(19) United States
(12) Patent Application Publication
(10) Pub. No.: US 2011/0167223 A1
(43) Pub. Date: Jul. 7, 2011

(54) BUFFER MEMORY DEVICE, MEMORY SYSTEM, AND DATA READING METHOD

(75) Inventor: Takanori ISONO, Kyoto (JP)

(73) Assignee: PANASONIC CORPORATION, Osaka (JP)

(21) Appl. No.: 13/050,090

(22) Filed: Mar. 17, 2011

Related U.S. Application Data
(63) Continuation of application No. PCT/JP2009/004595, filed on Sep. 15, 2009.

(30) Foreign Application Priority Data
Sep. 18, 2008 (JP) 2008-239927

(51) Int. Cl. G06F 12/08; G06F 12/00

(52) U.S. Cl. 711/119; 711/154; 711/118; 711/E12.001; 711/E12.017; 711/E12.023

(57) ABSTRACT

Memory access is accelerated by performing a burst read without any problems caused due to rewriting of data. A buffer memory device reads, in response to a read request from a processor, data from a main memory including cacheable and uncacheable areas. The buffer memory device includes an attribute obtaining unit which obtains the attribute of the area indicated by a read address included in the read request; an attribute determining unit which determines whether or not the attribute obtained by the attribute obtaining unit is burst-transferable; a data reading unit which performs a burst read of data including data held in the area indicated by the read address, when determined that the attribute obtained by the attribute obtaining unit is burst-transferable; and a buffer memory which holds the data burst read by the data reading unit.

### CROSS REFERENCE TO RELATED APPLICATION

This is a continuation application of PCT application No. PCT/JP2009/004595 filed on Sep. 15, 2009, designating the United States of America.

### BACKGROUND OF THE INVENTION

(1) Field of the Invention

The present invention relates to buffer memory devices, memory systems, and data reading methods, and in particular, to a buffer memory device, a memory system, and a data reading method which, when performing a burst read of data held in a main memory, hold the burst read data.

(2) Description of the Related Art

In recent years, in order to accelerate memory access from a microprocessor to a main memory, small and fast cache memories are used which are, for example, Static Random Access Memory (SRAM). It is possible to accelerate memory access by, for example, providing a cache memory inside or near a microprocessor and storing, in the cache memory, part of the data held in the main memory.

There is a conventional technique for further accelerating memory access (see Japanese Patent Application Publication No. 2004-240520, hereinafter referred to as Patent Document 1). In the technique, assuming that addresses continuous to the address included in a read request is likely to be accessed from a processor, data corresponding to the addresses is burst read in response to the read request.

FIG. 27 is a diagram schematically illustrating a conventional memory access method. As shown in FIG. 27, in the technique disclosed in Patent Document 1, a main memory 620 includes a cacheable area 621 and an uncacheable area 622.

In the case where a read request for the uncacheable area 622 is made by a processor 610 such as a Central Processing Unit (CPU), the burst read data is stored in a general-purpose register 612 in the processor 610. In the case where a read request for the cacheable area 621 is made, the burst read data is stored in a cache memory 611.

In such a manner, in the memory access method disclosed in Patent Document 1, memory access can be further accelerated by performing a burst read of data corresponding to the address that is likely to be accessed.

### SUMMARY OF THE INVENTION

However, the following problems exist in the conventional technique.

First, in the case where a read request for the uncacheable area 622 is made, the burst read data is stored in the general-purpose register 612 in the CPU as described above; however, the general-purpose register 612 is much more inefficient than the cache memory 611. Furthermore, the uncacheable area 622 has a read-sensitive area where the value of the held data changes when the data is read. When performing a burst read of data held in the uncacheable area 622, the read-sensitive area is also accessed, which results in rewriting of the data in the read-sensitive area.

In the case where a read request for the cacheable area 621 is made, the burst read data is stored in the cache memory 611 as described above; however, this causes rewriting of the data in the cache memory 611. Accordingly, the data stored in the cache memory 611 for accelerating the memory access is deleted; and thus, it is not possible to accelerate memory access.

The present invention has been conceived in view of the problems, and has an object to provide a buffer memory device, a memory system, and a data reading method which accelerate memory access by performing a burst read without any problems caused due to rewriting of data.

In order to solve the problems, a buffer memory device according an aspect of to the present invention is a buffer memory device which reads data from a main memory or a peripheral device in response to a read request from a processor, the main memory and the peripheral device including a plurality of areas each having either a cacheable attribute or an uncacheable attribute. The buffer memory device includes: an attribute obtaining unit which obtains an attribute of an area indicated by a read address included in the read request; an attribute determining unit which determines whether or not the attribute obtained by the attribute obtaining unit is a first attribute which (i) is the uncacheable attribute and (ii) indicates that data to be burst transferred is to be held; a data reading unit which performs a burst read of data including data held in the area indicated by the read address, when the attribute determining unit determines that the attribute obtained by the attribute obtaining unit is the first attribute; and a first buffer memory which holds the data burst read by the data reading unit.

According to this, the attribute of the area indicated by an address of the main memory or a peripheral device is determined and a burst read of data is performed from the area which is in the uncacheable area and which holds data to be burst transferred; and thus, it is possible to prevent data in the other areas in the main memory or in the peripheral device from being unintentionally rewritten. Furthermore, the burst read data can be held in the buffer memory in advance; and thus, it is possible to accelerate memory access. In addition, by storing the burst read data in a buffer memory that is different from a cache memory, it is possible to increase the area for holding data without using the cache memory.

It may be that the attribute determining unit determines whether the attribute obtained by the attribute obtaining unit is the first attribute or a second attribute which (i) is the uncacheable attribute and (ii) indicates that data to be burst transferred is not to be held, and the data reading unit further reads only data held in the area indicated by the read address, when the attribute determining unit determines that the attribute obtained by the attribute obtaining unit is the second attribute.

According to this, it is possible to prevent a burst read of data from the area not to be burst read; and thus, it is possible to prevent data from being unintentionally rewritten.

It may also be that the buffer memory device further includes a table holding unit which holds a table in which an address of the main memory or the peripheral device is associated with attribute information, the attribute information indicating the attribute of the area indicated by the address from among the first attribute, the second attribute, and a third attribute that is the cacheable attribute, in which the attribute obtaining unit obtains the attribute of the area indicated by the read address with reference to the table held by the table holding unit.

According to this, it is easy to manage relationship between attributes and areas indicated by the addresses of the main memory or peripheral devices. Therefore, the attribute can be obtained by simply referring to the table, which simplifies the structure of the buffer memory device according to an aspect of the present invention.

It may also be that the buffer memory device further includes a cache memory, and that the attribute determining unit determines the attribute obtained by the attribute obtaining unit from among the first attribute, the second attribute, and the third attribute, the data reading unit further performs a burst read of data including data held in the area indicated by the read address, when the attribute determining unit determines that the attribute obtained by the attribute obtaining unit is the third attribute, the cache memory holds first data including data held in the area indicated by the read address out of the data burst read by the data reading unit, and the first buffer memory holds second data from among the data burst read by the reading unit, the second data excluding the first data.

According to this, the buffer memory is also used. Thus, compared to the case where only the cache memory is used, data can also be held in the buffer memory in advance. This allows further accelerating of memory access.

It may also be that the buffer memory device further includes an attribute setting unit which generates the table by setting the attribute of the area indicated by the address of the main memory or the peripheral device to one of the first attribute, the second attribute, and the third attribute, and that the table holding unit holds the table generated by the attribute setting unit.

According to this, it is possible to, for example, change the attribute as necessary.

It may also be that the data reading unit: when the attribute determining unit determines that the attribute obtained by the attribute obtaining unit is the first attribute, determine whether or not the data held in the area indicated by the read address is already held in the first buffer memory; when the data is already held in the first buffer memory, read the data from the first buffer memory; and when the data is not held in the first buffer memory, perform a burst read of data including the data held in the area indicated by the read address.

According to this, the buffer memory can be operated in the same manner as the cache memory; and thus, it is possible to accelerate memory access.

It may also be that the attribute obtaining unit obtains an attribute of an area indicated by a write address included in a write request from the processor, and that the buffer memory device further includes: a second buffer memory which holds write data that corresponds to the write request and that is to be written to the main memory or the peripheral device, when the attribute determining unit determines that the attribute of the area indicated by the write address out of the attribute obtained by the attribute obtaining unit is the first attribute; a memory access information obtaining unit which obtains memory access information indicating a type of the memory access request that is the read request or the write request from the processor; a condition determining unit which determines whether or not the type indicated by the memory access information obtained by the memory access information obtaining unit or the attribute obtained by the attribute obtaining unit meets a predetermined condition; and a control unit which drains the write data held in the second buffer memory to the main memory or the peripheral device, when the condition determining unit determines that the type indicated by the memory access information meets the predetermined condition.

With this, by using the buffer memory, it is possible to merge data at the writing of the data, and to perform a burst write of the merged data to the main memory or the peripheral device. As a result, it is possible to increase the efficiency of data transfer.

It may also be that the memory access information obtaining unit obtains, as the memory access information, processor information indicating a logical processor and a physical processor which have issued the memory access request, the condition determining unit determines that the predetermined condition is met, in the case where the second buffer memory holds write data corresponding to a write request previously issued by (i) a physical processor that is different from the physical processor indicated by the processor information and (ii) a logical processor that is same as the logical processor indicated by the processor information, and when the condition determining unit determines that the predetermined condition is met, the control unit drains, to the main memory or the peripheral device, the data held in the second buffer memory which meets the predetermined condition.

According to this, by writing data, corresponding to a write request previously issued, into the main memory or the peripheral device, it is possible to maintain data coherency. In the case where memory access requests are issued by a same logical processor but different physical processors, data output by the same logical processor may be held in different buffer memories. When it happens, data coherency cannot be maintained between respective buffer memories. By draining the data held in the buffer memory to the main memory or the peripheral device, it is possible to overcome the problem of the data coherency between the buffer memories.

It may also be that the condition determining unit determines whether or not the memory access information includes command information for draining the data held in the second buffer memory to the main memory or the peripheral device, and when the condition determining unit determines that the memory access information includes the command information, the control unit drains, to the main memory or the peripheral device, the data indicated by the command information and held in the second buffer memory.

According to this, the data held in the buffer memory can be easily drained to the main memory or the peripheral device based on an instruction from the processor, so that the data in the main memory or the peripheral device can be updated.

It may also be that the memory access information obtaining unit obtains, as the memory access information, processor information indicating a processor which has issued the memory access request, the condition determining unit further determines whether or not the attribute indicated by the attribute information is the first attribute, and when the condition determining unit determines that the attribute obtained by the attribute obtaining unit is the first attribute, the control unit further drains, to the main memory or the peripheral device, the data held in the second buffer memory corresponding to the processor indicated by the processor information.

This maintains the order of the write requests issued by the processor. As a result, data coherency can be maintained.

It may also be that the second buffer memory further holds a write address corresponding to the write data, when the memory access request includes the read request, the memory access information obtaining unit further obtains, as the memory access information, a read address included in the read request, the condition determining unit determines whether or not a write address which matches the read address is held in the second buffer memory, and when the condition determining unit determines that the write address which matches the read address is held in the second buffer memory, the control unit drains, to the main memory or the peripheral device, the data held in the second buffer memory prior to the write data corresponding to the write address.

According to this, before data is read from the area indicated by the read address, the data in the area can be always updated; and thus, it is possible to prevent old data from being read by the processor.

It may also be that when the memory access request includes the write request, the memory access information obtaining unit obtains a first write address included in the write request, the condition determining unit determines whether or not the first write address is continuous with a second write address included in an immediately prior write request, and when the condition determining unit determines that the first write address is continuous with the second write address, the control unit drains, to the main memory or the peripheral device, the data held in the second buffer memory prior to write data corresponding to the second write address.

Generally, when a processor performs a sequence of processing, the processor often access continuous areas indicated by continuous addresses; and thus, when the addresses are not continuous, it can be assumed that different processing has started. Thus, data related to the sequence of processing is drained to the main memory or the peripheral device. Accordingly, the data related to other processing can be held in the buffer memory, which allows efficient use of the buffer memory.

It may also be that the condition determining unit determines whether or not an amount of data held in the second buffer memory reaches a predetermined threshold, and when the condition determining unit determines that the data amount reaches the predetermined threshold, the control unit drains the data held in the second buffer memory to the main memory or the peripheral device.

Accordingly, when the data amount in the buffer memory reaches an adequate amount, the data can be drained. For example, data can be drained when the data amount is equivalent to the maximum data amount that can be held in the buffer memory or, to the data bus width between the buffer memory and the main memory or the peripheral device.

It may also be that the buffer memory device further includes an invalidating unit which determines whether or not a write address included in a write request from the processor matches an address of the data held in the first buffer memory, and to invalidate the data held in the first buffer memory when the write address matches the address of the data held in the first buffer memory.

According to this, when the data held in the buffer memory does not match the corresponding data held in the main memory or the peripheral device, it is possible to prevent the processor from reading the data from the buffer memory.

Furthermore, the present invention may be implemented as a memory system. The memory system according to an aspect of the present invention includes (i) a processor and (ii) a main memory or a peripheral device which includes a plurality of areas each having either a cacheable attribute or an uncacheable attribute, wherein data is read from the main memory or the peripheral device in response to a read request from the processor. The system further includes: an attribute obtaining unit which obtains an attribute of an area indicated by a read address included in the read request from the processor; an attribute determining unit which determines whether or not the attribute obtained by the attribute obtaining unit is a first attribute which (i) is the uncacheable attribute and (ii) indicates that data to be burst transferred is to be held; a data reading unit which performs a burst read of data including data held in the area indicated by the read address, when the attribute determining unit determines that the attribute obtained by the attribute obtaining unit is the first attribute; and a buffer memory which holds the data burst read by the data reading unit, wherein the data reading unit further: when the attribute determining unit determines that the attribute obtained by the attribute obtaining unit is the first attribute, determines whether or not the data held in the area indicated by the read address is already held in the buffer memory; when the data is already held in the buffer memory, reads the data from the buffer memory; and when the data is not held in the buffer memory, performs a burst read of data including the data held in the area indicated by the read address.

It may also be that the memory system further includes: a plurality of caches, wherein the buffer memory is included in a cache, among the caches, which is closest to the main memory or the peripheral device.

The present invention may be implemented not only as a buffer memory device and a memory system, but also as a method having processing units included in the memory system as steps. The steps may be implemented as computer programs executed by a computer. Furthermore, the present invention may be implemented as a recording medium such as a computer-readable Compact Disc-Read Only Memory (CD-ROM) storing the programs, and as information, data or signals indicating the programs. Such program, information and signals may be distributed over communications network such as the Internet.

According to the buffer memory device, the memory system, and the data reading method according to the present invention, it is possible to accelerate memory access by performing a burst read without causing problems resultant from data being rewritten.

### FURTHER INFORMATION ABOUT TECHNICAL BACKGROUND TO THIS APPLICATION

The disclosure of Japanese Patent Application No. 2008-239927 filed on Sep. 18, 2008 including specification, drawings and claims is incorporated herein by reference in its entirety.

The disclosure of PCT application No. PCT/JP2009/004595 filed on Sep. 15, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram schematically illustrating a system including a processor, a main memory, and cache memories according to Embodiment 1;

FIG. 2 is a diagram illustrating attributes set in an address space according to Embodiment 1;

FIG. 3 is a block diagram illustrating a structure of a buffer memory device according to Embodiment 1;

FIG. 4 is a diagram illustrating an example of an area attribute table according to Embodiment 1;

FIG. 5 is a diagram illustrating details of a buffer memory and a cache memory according to Embodiment 1;

FIG. 6 is a flowchart of operations of the buffer memory device according to Embodiment 1;

FIG. 7 is a flowchart of details of transfer processing performed when the attribute is burst-transferable;

FIG. 8 is a flowchart of details of transfer processing performed when the attribute is non-burst-transferable;

FIG. 9 is a flowchart of details of transfer processing performed when the attribute is cacheable;

FIG. 10 is a block diagram illustrating a structure of a buffer memory device according to Embodiment 2;

FIG. 11 is a flowchart of details of transfer processing performed when the attribute is cacheable;

FIG. 12 is a block diagram illustrating a structure of a memory system according to Embodiment 3;

FIG. 13 is a diagram illustrating an example of an address conversion table according to Embodiment 3;

FIG. 14 is a block diagram illustrating a structure of a buffer memory device according to Embodiment 4;

FIG. 15 is a diagram illustrating an example of memory access information according to Embodiment 4;

FIG. 16 is a block diagram schematically illustrating a buffer memory included in the buffer memory device according to Embodiment 4;

FIG. 17 illustrates a determination table showing an example of determining conditions according to Embodiment 4;

FIG. 18 is a block diagram illustrating a detailed structure of a determining unit according to Embodiment 4;

FIG. 19 is a flowchart of operations of the buffer memory device according to Embodiment 4;

FIG. 20 is a flowchart illustrating write processing of the buffer memory device according to Embodiment 4;

FIG. 21 is a flowchart of attribute determination processing of the buffer memory device according to Embodiment 4;

FIG. 22 is a flowchart of command determination processing of the buffer memory device according to Embodiment 4;

FIG. 23 is a flowchart illustrating read address determination processing of the buffer memory device according to Embodiment 4;

FIG. 24 is a flowchart illustrating write address determination processing of the buffer memory device according to Embodiment 4;

FIG. 25 is a flowchart of buffer amount determination processing of the buffer memory device according to Embodiment 4;

FIG. 26 is a flowchart of processor determination processing of the buffer memory device according to Embodiment 4; and

FIG. 27 is a diagram schematically illustrating a conventional memory access method.

### DESCRIPTION OF THE PREFERRED EMBODIMENT(S)

Hereinafter, the present invention will be described in details based on embodiments with reference to the drawings.

### Embodiment 1

First, reference is made to a general memory system which includes a buffer memory device according to Embodiment 1.

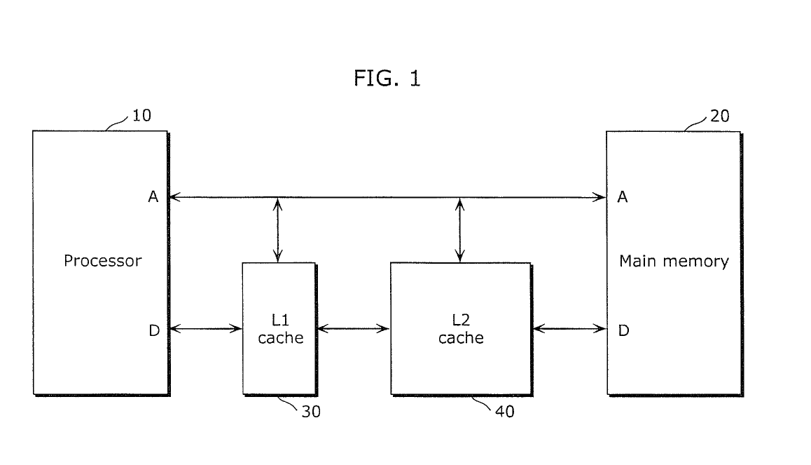

FIG. 1 is a block diagram schematically illustrating a system including a processor, a main memory, and cache memories according to Embodiment 1. As shown in FIG. 1, the system according to Embodiment 1 includes a processor 10, a main memory 20, an L1 (level 1) cache 30, and an L2 (level 2) cache 40.

The buffer memory device according to Embodiment 1 is provided, for example, between the processor 10 and the main memory 20 in the system as shown in FIG. 1. More specifically, a buffer memory included in the buffer memory device is included in the L2 cache 40.

The processor 10 outputs a memory access request to the main memory 20. The memory access request is, for example, a read request for reading data, or a write request for writing data. The read request includes a read address indicating the area from which data is to be read. The write request includes a write address indicating the area to which data is to be written.

The main memory 20 includes a plurality of areas each having either a cacheable attribute or an uncacheable attribute. The main memory 20 is a large-capacity main memory, such as a Synchronous Dynamic Random Access Memory (SDRAM), for storing programs, data, and the like in the areas. In response to a memory access request (read request or write request) output from the processor 10, data is read from the main memory 20 or data is written into the main memory 20.

The L1 cache 30 and the L2 cache 40 are cache memories such as an SRAM for storing part of the data read by the processor 10 from the main memory 20 and part of the data to be written by the processor 10 into the main memory 20. The L1 cache 30 and the L2 cache 40 are cache memories which have capacities smaller than that of the main memory 20, but which is capable of operating at high speed. The L1 cache 30 is a cache memory which has a higher priority and is provided closer to the processor 10 than the L2 cache 40. Generally, the L1 cache 30 has a smaller capacity, but is capable of operating at a higher speed compared to the L2 cache 40.

The L1 cache 30 obtains the memory access request output from the processor 10, and determines whether data corresponding to the address included in the obtained memory access request is already stored (hit) or not stored (miss). For example, when the read request is a hit, the L1 cache 30 reads the data corresponding to the read address included in the read request from inside the L1 cache 30, and outputs the data to the processor 10. The data corresponding to the read address refers to the data stored in the area indicated by the read address. When the write request is a hit, the L1 cache 30 writes, into the L1 cache 30, the data output from the processor 10 at the same time as the write request.

When the read request is a miss, the L1 cache 30 reads data corresponding to the read request from the L2 cache 40 or the main memory 20, and outputs the data to the processor 10. When the write request is a miss, the L1 cache 30 performs refill processing, updates a tag address, and writes the data output from the processor 10 at the same time as the write request.

The L2 cache 40 obtains the memory access request output from the processor 10, and determines whether or not the obtained memory access request is a hit or a miss. When the read request is a hit, the L2 cache 40 reads, from inside the L2 cache 40, the data corresponding to the read address included in the read request, and outputs the data to the processor 10 via the L1 cache 30. When the write request is a hit, the L2 cache 40 writes, into inside the L2 cache 40 via the L1 cache 30, the data output from the processor 10 at the same times as the write request.

When the read request is a miss, the L2 cache 40 reads the data corresponding to the read request from the main memory 20, and outputs the data to the processor 10 via the L1 cache 30. When the write request is a miss, the L2 cache 40 performs refill processing, updates a tag address, and writes the data output from the processor 10 at the same time as the write request, via the L1 cache 30.

In the system shown in FIG. 1, processing is performed for maintaining coherency between the main memory 20, the L1 cache 30, and the L2 cache 40. For example, the data written into the cache memory in accordance with a write request is written into the main memory 20 through a write-through operation or a write-back operation.

When the write request is a miss, the processor 10 may write data into the main memory 20 without refilling or updating the L1 cache 30. The same also applies to the L2 cache 40.

Although FIG. 1 illustrates the structure where the L1 cache 30 is provided outside the processor 10, the L1 cache 30 may be included in the processor 10.

The data may be transferred to and from, not only the main memory 20, but also another peripheral device such as an input/output (IO) device. The peripheral device refers to a device which transfers data to and from the processor 10, and is, for example, a keyboard, a mouse, a display, or a floppy (registered trademark) disk drive.

Next, reference is made to the main memory 20 according to Embodiment 1.

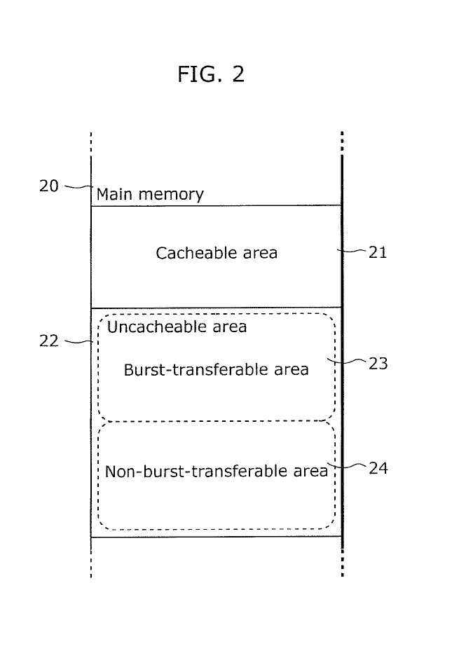

FIG. 2 is a diagram illustrating attributes set in an address space according to Embodiment 1. The area of the address space is assigned to the main memory 20, other peripheral devices, and the like. As shown in FIG. 2, the main memory 20 includes a cacheable area 21 and an uncacheable area 22.

The cacheable area 21 is an area having a cacheable attribute which indicates that data to be cached to the cache memories, such as the L1 cache 30 or the L2 cache 40, can be held.

The uncacheable area 22 is an area having an uncacheable attribute which indicates that data that is not to be cached to the cache memories, such as the L1 cache 30 or the L2 cache 40, can be held. The uncacheable area 22 includes a burst-transferable area 23 and a non-burst-transferable area 24.

The burst-transferable area 23 is an area having a burst-transferable attribute which indicates that data, which is not to be cached to the cache memory and which is to be burst transferred, can be held. The burst transfer refers to transferring data collectively, and is, for example, a burst read or a burst write. The burst-transferable area 23 is, for example, an area that is not read-sensitive.

The non-burst-transferable area 24 is an area having a non-burst-transferable attribute which indicates that data, which is not to be cached to the cache memory and which is to be burst transferred, can not be held. The non-burst-transferable area 24 is, for example, a read-sensitive area.

As described, the main memory 20 according to Embodiment 1 has areas each set to one of the three exclusive attributes.

Next, reference is made to the buffer memory device according to Embodiment 1.

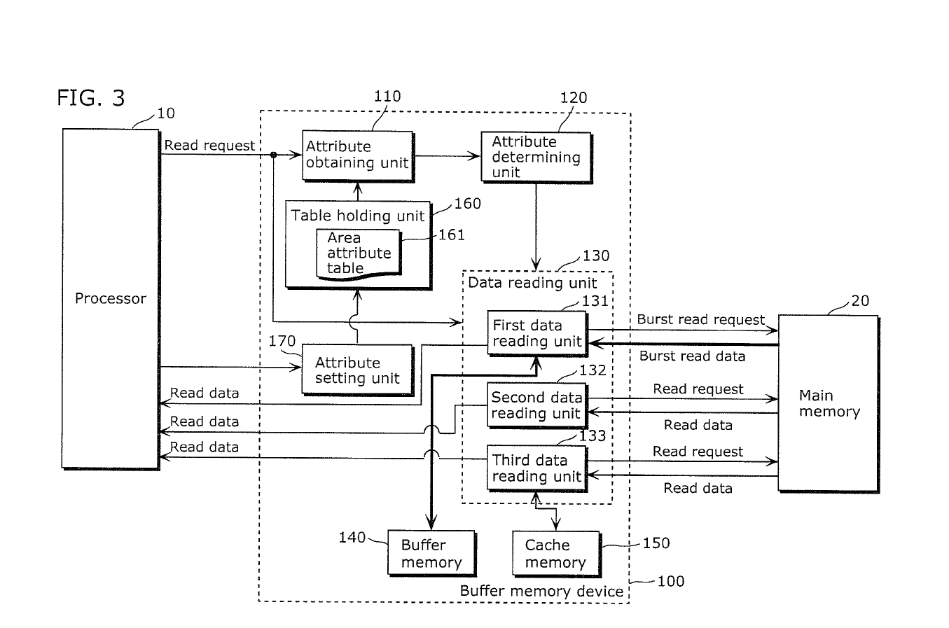

FIG. 3 is a block diagram illustrating a structure of the buffer memory device according to Embodiment 1. It is assumed that a buffer memory device 100 shown in FIG. 3 is provided on the same chip as the L2 cache 40 shown in FIG. 1, and performs data transfer between the processor 10 and the main memory 20. In FIG. 3, the processor 10 includes the L1 cache 30, and the L1 cache 30 is not illustrated.

As shown in FIG. 3, the buffer memory device 100 includes an attribute obtaining unit 110, an attribute determining unit 120, a data reading unit 130, a buffer memory 140, a cache memory 150, a table holding unit 160, and an attribute setting unit 170. The buffer memory device 100 reads data corresponding to a read request output from the processor 10, from the main memory 20, the buffer memory 140, or the cache memory 150, and transfers the data to the processor 10.

The attribute obtaining unit 110 obtains the attribute of the area indicated by an address (hereinafter, also referred to as a read address) included in the read request. More specifically, the attribute obtaining unit 110 obtains the attribute of the area indicated by the read address, with reference to an area attribute table 161 held by the table holding unit 160.

Here, the attribute of the area includes three attributes as described above, which are cacheable, burst-transferable and non-burst-transferable. The cacheable attribute indicates that the area is the cacheable area 21. The burst-transferable attribute indicates the area is the burst-transferable area 23 of the uncacheable area 22. The non-burst-transferable attribute indicates the area is the non-burst-transferable area 24 of the uncacheable area 22.

The attribute determining unit 120 determines the attribute obtained by the attribute obtaining unit 110 from among cacheable, burst-transferable, and non-burst-transferable attribute.

The data reading unit 130 reads data corresponding to the read request, from the main memory 20, the buffer memory 140, or the cache memory 150, in accordance with the determination result of the attribute determining unit 120. Here, the data reading unit 130 includes a first data reading unit 131, a second data reading unit 132, and a third data reading unit 133.

The first data reading unit 131 reads data held in the area indicated by the read address, when the attribute determining unit 120 determines that the attribute of the area indicated by the address included in the read request is burst-transferable. The first data reading unit 131 also determines whether the read request is a hit or a miss.

When the read request is a hit, the first data reading unit 131 reads data corresponding to the read address (hereinafter, also referred to as read data) from the buffer memory 140, and outputs the data to the processor 10. When the read request is a miss, the first data reading unit 131 performs a burst read of data including the read data from the main memory 20, and stores the data (hereinafter, also referred to as burst read data) into the buffer memory 140. Of the stored burst read data, the first data reading unit 131 outputs only the read data to the processor 10. The storage of the burst read data into the buffer memory 140 may be executed in parallel with the output of the read data to the processor 10.

Here, the burst read data is, for example, read data and data that is likely to be used with the read data. Generally, the data that is likely to be used with the read data is data corresponding to an address continuous to the read address. The sizes of the read data and the burst read data are determined based on, for example, the data bus width between the processor 10, the main memory 20, the buffer memory device 100 and the like, the size of the buffer memory 140, and an instruction from the processor 10. Here, as an example, the size of the read data is 4 bytes, and the size of the burst read data is 64 bytes.

In Embodiment 1, similar to the cache memory, the case where data corresponding to a read address is already held in the buffer memory 140 is referred to as “the read request is a hit”, and the case where data corresponding to a read address is not held in the buffer memory 140 is referred to as “the read request is a miss”.

The second data reading unit 132 reads data, when the attribute determining unit 120 determines that the attribute of the area indicated by the address included in the read request is non-burst-transferable. More specifically, the second data reading unit 132 reads only the data corresponding to the read address (read data) from the main memory 20, and outputs the data to the processor 10.

The third data reading unit 133 reads data, when the attribute determining unit 120 determines that the attribute of the area indicated by the address included in the read request is cacheable. The third data reading unit 133 also determines whether the read request is a hit or a miss.

More specifically, when the read request is a hit, the third data reading unit 133 reads data corresponding to the read address (read data) from the cache memory 150, and outputs the data to the processor 10. When the read request is a miss, the third data reading unit 133 reads read data from the main memory 20, and stores the data into the cache memory 150. Then, the stored read data is transferred to the processor 10. The storage of the read data read from the main memory 20 into the cache memory 150 may be executed in parallel with the output to the processor 10.

The buffer memory 140 is a storage unit, such as a memory, for storing data burst read (burst read data) from the main memory 20 by the first data reading unit 131. The buffer memory 140 stores burst read data in association with their addresses.

The cache memory 150 is a cache memory for holding data read by the third data reading unit 133 from the main memory 20. The cache memory 150 includes a tag area for storing addresses, and a data area for storing data. In Embodiment 1, the cache memory 150 corresponds to the L2 cache 40 in FIG. 1.

The table holding unit 160 is a storage unit, such as a memory, for holding the area attribute table 161 in which addresses of the main memory and attributes of the respective areas are associated. The area attribute table 161 is generated and changed by the attribute setting unit 170.

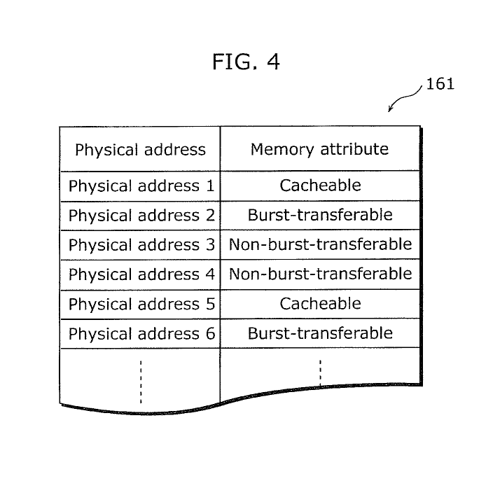

Here, reference is made to FIG. 4. FIG. 4 is a diagram illustrating an example of the area attribute table 161 according to Embodiment 1. As shown in FIG. 4, the area attribute table 161 is a table in which physical addresses of the main memory 20 are associated with the attributes of the areas indicated by the respective physical addresses. In FIG. 4, “cacheable” represents the cacheable attribute, “burst-transferable” represents the burst-transferable attribute, and “non-burst-transferable” represents the non-burst-transferable attribute. For example, in the example of FIG. 4, when the read address is “physical address 3”, the attribute obtaining unit 110 obtains the non-burst-transferable attribute as the attribute of the area indicated by the read address, with reference to the area attribute table 161.

Referring back to FIG. 3, the attribute setting unit 170 sets the attribute corresponding to the address of the main memory 20 to one of cacheable, burst-transferable, and non-burst-transferable. These attributes are set depending on the types or the like of the data stored in the main memory 20, in response to an instruction from the processor 10.

For example, the attribute setting unit 170 sets the read-sensitive area of the uncacheable area to the non-burst-transferable attribute. Alternatively, the attribute setting unit 170 sets the attribute of each address in accordance with data availability. More specifically, the attribute setting unit 170 sets, to the cacheable attribute, the address indicating the area which stores data that is likely to be sequentially read and be used many times. The attribute setting unit 170 sets, to the burst-transferable attribute, the address indicating the area which stores data that is likely to be sequentially read but be used only once. The address indicating the area which stores other data is set to the non-burst-transferable attribute. The address indicating the area which stores no data is set to any one of the above attributes arbitrarily or as necessary.

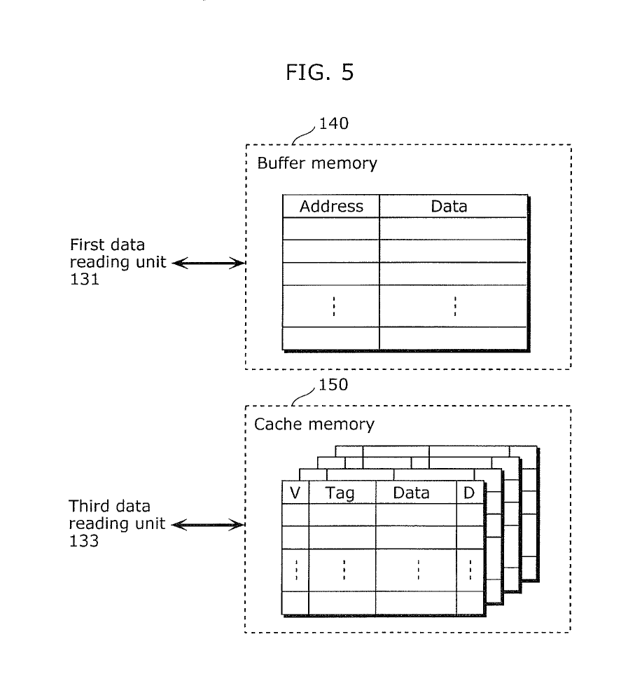

Here, the structures of the buffer memory 140 and the cache memory 150 according to Embodiment 1 are described. FIG. 5 is a diagram illustrating the details of the buffer memory 140 and the cache memory 150 according to Embodiment 1.

As shown in FIG. 5, the buffer memory 140 stores addresses of the main memory 20 (physical addresses) in association with the data read by the first data reading unit 131 from the areas indicated by the respective addresses. The buffer memory 140 is capable of storing a plurality of pieces of data (for example, 8 pieces of data) of predetermined bytes (for example, 64 bytes). In Embodiment 1, the buffer memory 140 is used only for reading data from the main memory 20. In other words, the buffer memory 140 is not used for writing data into the main memory 20. The buffer memory 140 is a Prefetch Buffer (PFB) which, in advance, stores data that is likely to be read.

The cache memory 150 is, for example, a four-way set associative cache memory as shown in FIG. 5. The cache memory 150 has four ways which have the same structure. Each way has a plurality of cache entries (for example, 1024 cache entries). One cache entry includes a valid flag V, a tag, line data, and a dirty flag D.

The valid flag V is a flag indicating whether or not the data of the cache entry is valid. The tag is a copy of a tag address. The line data is a copy of data of predetermined bytes (for example, data of 64 bytes) in a block specified by the tag address and a set index. The dirty flag D is a flag indicating whether or not it is necessary to write back the cached data into the main memory.

As described above, the buffer memory 140 according to Embodiment 1 stores addresses in association with data, similar to the relationship between the tags and data of the cache memory.

The number of ways included in the cache memory 150 is not limited to four. The number of cache entries in one way and the number of bytes of line data of one cache entry are also not limitative. The cache memory 150 may be any other types of cache memory.

For example, it may be a direct mapped cache memory or a fully associative cache memory.

As described above, the buffer memory device 100 according to Embodiment 1 includes the buffer memory 140 which stores the data burst read from the non-burst-transferable area 24 that stores data to be burst read, out of the uncacheable area 22 of the main memory 20 which includes the cacheable area 21 and the uncacheable area 22.

Accordingly, in response to a read request, a burst read of data corresponding to the read request and data that is likely to be subsequently read is performed; and thus, it is possible to accelerate memory access.

It is assumed that the buffer memory device 100 shown in FIG. 3 also includes a processing unit which executes write processing of write data corresponding to a write request.

For example, the attribute obtaining unit 110 obtains the attribute of the area indicated by the write address included in the write request, similar to the read request. The attribute determining unit 120 determines the attribute obtained by the attribute obtaining unit 110 from among cacheable, burst-transferable, and non-burst-transferable attribute. A data writing unit (not illustrated) writes write data to the cache memory 150 or the main memory 20 based on the determination result.

More specifically, when the attribute is cacheable, the write data is written to the cache memory 150. When the attribute is uncacheable, the write data is written to the main memory 20. Here, when writing to the cache memory 150, it is determined whether or not the write request is a hit or a miss. When it is a hit, the write data is written to the cache memory 150. When it is a miss, the write data is written to the main memory 20.

In such a manner, the buffer memory device 100 according to Embodiment 1 is also capable of writing write data in response to a write request from the processor 10.

Here, it may be that the data reading unit 130 determines whether or not the write address matches the address corresponding to the data held in the buffer memory 140, and invalidates the data held in the buffer memory 140 when a match is found. For example, data is invalided by setting, to the corresponding data, a flag indicating that the data is invalid or by deleting the corresponding data from the buffer memory 140.

Accordingly, data coherency can be maintained between the main memory 20 and the buffer memory 140. More specifically, in the case where new data is written only to the main memory 20 and the data that has been written to the buffer memory 140 is old, it is possible to prevent the old data from being read from the buffer memory 140.

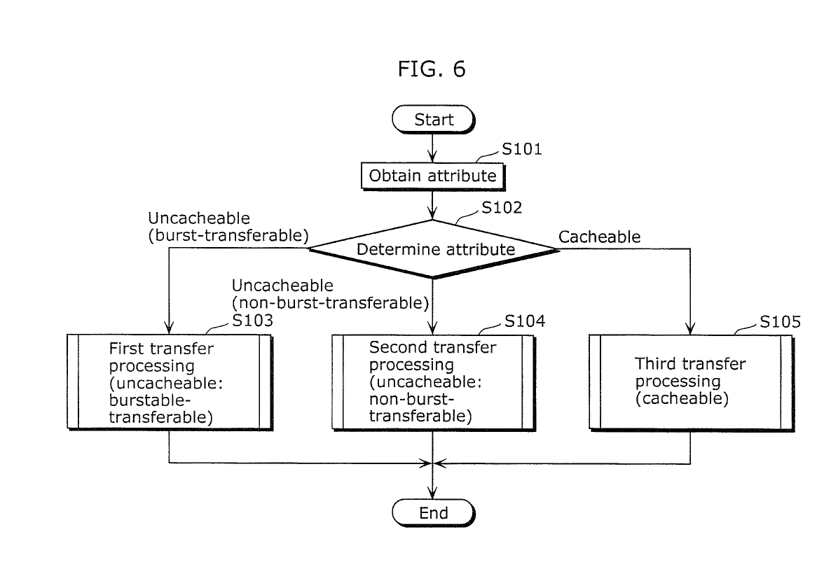

Next, reference is made to the operations of the buffer memory device 100 according to Embodiment 1, with reference to FIGS. 6 to 9. FIG. 6 is a flowchart of the operations of the buffer memory device 100 according to Embodiment 1.

First, the buffer memory device 100 executes read processing according to Embodiment 1 upon receipt of a read request from the processor 10.

The attribute obtaining unit 110 obtains the attribute of the area indicated by the read address, with reference to the area attribute table 161 (S101). The attribute determining unit 120 then determines the attribute obtained by the attribute obtaining unit 110 from among cacheable, burst-transferable and non-burst-transferable attribute (S102).

When determined that the attribute of the area indicated by the read address is burst-transferable (“uncacheable (burst-transferable) in S102), the first data reading unit 131 executes first transfer processing (S103). The first transfer processing is processing executed when the attribute is burst-transferable, and is processing where, when transferring data to the processor 10, a burst read of data is performed from the main memory 20 and the burst read data is stored in the buffer memory 140.

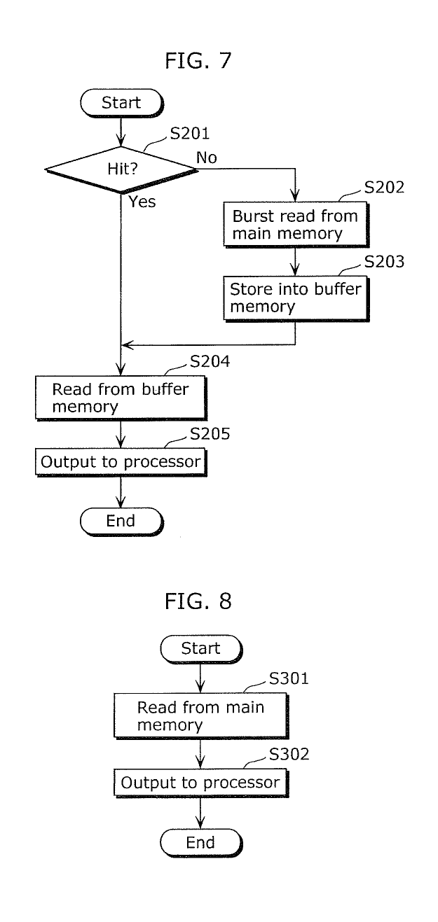

Here, reference is made to FIG. 7. FIG. 7 is a flowchart of the details of the transfer processing performed when the attribute is burst-transferable.

The first data reading unit 131 determines whether the read request is a hit or a miss (S201). When the read request is a miss (No in S201), the first data reading unit 131 performs a burst read of burst read data including read data from the main memory 20 (S202). The first data reading unit 131 then stores the burst read data into the buffer memory 140 (S203). Furthermore, the first data reading unit 131 reads read data from the buffer memory 140 (S204) and outputs the data to the processor 10 (S205). Here, the storage of the burst read data into the buffer memory 140 may be executed at the same time of the output of the read data to the processor 10.

When the read request is a hit (Yes in S201), the first data reading unit 131 reads read data corresponding to the read request from the buffer memory 140 (S204). The first data reading unit 131 then outputs the data to the processor 10 (S205).

Returning to FIG. 6, when determined that the attribute of the area indicated by the read address is non-burst-transferable (“uncacheable (non-burst-transferable) in S102), the second data reading unit 132 executes second transfer processing (S104). The second transfer processing is processing executed when the attribute is non-burst-transferable, and processing where data is read from the main memory 20 and the data is transferred to the processor 10.

Here, reference is made to FIG. 8. FIG. 8 is a flowchart of the details of the transfer processing performed when the attribute is non-burst-transferable.

The second data reading unit 132 reads read data from the main memory 20 (S301). The second data reading unit 132 then outputs the data to the processor 10 (S302).

Returning to FIG. 6 again, when determined that the attribute of the area indicated by the read address is cacheable (“cacheable” in S102), the third data reading unit 133 executes third transfer processing (S105). The third transfer processing is processing executed when the attribute is cacheable and processing where, when transferring data to the processor 10, the data is read from the main memory 20 and the data is stored in the cache memory 150.

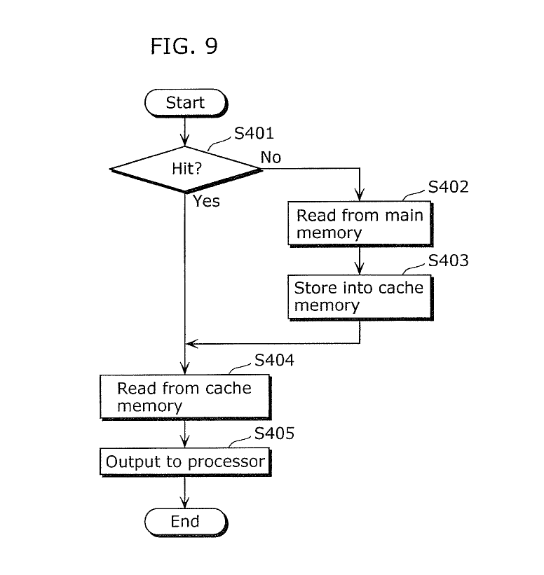

Here, reference is made to FIG. 9. FIG. 9 is a flowchart of the details of transfer processing performed when the attribute is cacheable.

The third data reading unit 133 determines whether the read request is a hit or a miss (S401). When the read request is a miss (No in S401), the third data reading unit 133 reads read data from the main memory 20 (S402). The third data reading unit 133 then stores the read data into the cache memory 150 (S403). Furthermore, the third data reading unit 133 reads read data from the cache memory 150 (S404) and outputs the data to the processor 10 (S405). Here, the storage of the read data into the cache memory 150 may be executed at the same time as the output to the processor 10.

When the read request is a hit (Yes in S401), the third data reading unit 133 reads read data corresponding to the read request from the cache memory 150 (S404). The third data reading unit 133 then outputs the data to the processor 10 (S405).

In such a manner, the buffer memory device 100 according to Embodiment 1 determines the attribute of the area indicated by the read address, and reads data in accordance with the determination result.

As described above, the buffer memory device 100 according to Embodiment 1 includes the buffer memory 140, which holds data burst read from the non-burst-transferable area 24 that holds data to be burst read, out of the uncacheable area 22 of the main memory 20 which includes the cacheable area 21 and the uncacheable area 22. The attribute of the area indicated by the read address is determined, and data is read in accordance with the determination result. Here, when the attribute is burst-transferable, the data burst read from the main memory 20 is stored in the buffer memory 140.

Accordingly, with use of the read-specific buffer memory 140, use of the cache memory can be prevented. As a result, data that is likely to be frequently used can be held in the cache memory. Furthermore, it is possible to prevent problems caused due to reading data more than necessary, by providing, in the main memory 20, an area that does not allow a burst read. In addition, it is also possible to accelerate memory access by providing, in the main memory 20, an area that allows a burst read.

### Embodiment 2

A buffer memory device according to Embodiment 2 performs a burst read of data including data corresponding to a read request, when the attribute indicated by the address included in the read request is cacheable. Accordingly, memory access can be further accelerated.

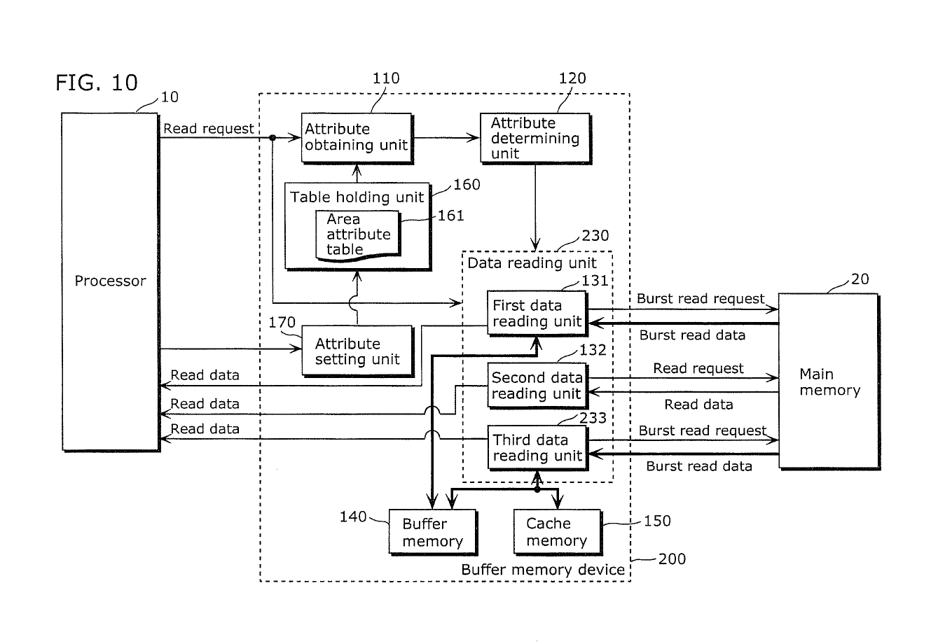

FIG. 10 is a block diagram illustrating a structure of the buffer memory device according to Embodiment 2. A buffer memory device 200 shown in FIG. 10 differs from the buffer memory device 100 shown in FIG. 3 in that a data reading unit 230 is included instead of the data reading unit 130. Note that the same reference numbers are used to the elements same as those in Embodiment 1. In the following, different points are mainly described, and descriptions of the same points may be omitted.

The data reading unit 230 reads data corresponding to a read request, from the main memory 20, the buffer memory 140, or the cache memory 150, in accordance with the determination result of the attribute determining unit 120. Here, the data reading unit 230 includes the first data reading unit 131, the second data reading unit 132, and a third data reading unit 233.

The third data reading unit 233 reads data, when the attribute determining unit 120 determines that the attribute of the area indicated by the address included in the read request is cacheable. The third data reading unit 233 also determines whether the read request is a hit or a miss.

More specifically, when the read request is a hit, the third data reading unit 233 reads data corresponding to the read address from the cache memory 150 or the buffer memory 140, and outputs the data to the processor 10. When the read request is a miss, the third data reading unit 233 performs a burst read of data including read data from the main memory 20, and stores the data burst read (burst read data) into the cache memory 150 and the buffer memory 140.

For example, of the burst read data, data including read data is stored in the cache memory 150, and the remaining data of the burst read data other than the data held in the cache memory 150 is stored in the buffer memory 140. Of the stored burst read data, the read data is read from the cache memory 150, and output to the processor 10. The storage of the burst read data into the cache memory 150 and the buffer memory 140 may be executed in parallel with the output of the read data to the processor 10.

For example, when the read request of the read data of 64 bytes is made from the processor 10, the third data reading unit 233 performs a burst read of data of 128 bytes including the read data. The third data reading unit 233 then stores, into the cache memory 150, the read data of 64 bytes out of the burst read data of 128 bytes, and also stores the remaining 64 bytes in the buffer memory 140.

As shown in the above structure, when determined that the attribute of the area indicated by the read address is cacheable attribute, the buffer memory device 200 according to Embodiment 2 performs a burst read of data including data corresponding to the read address, and stores the burst read data into the cache memory 150 and the buffer memory 140.

Accordingly, also at the time of performing a cache operation, a burst read is performed of data in response to a read request and data that is likely to be subsequently read, thereby further accelerating memory access.

Next, reference is made to the operations of the buffer memory device 200 according to Embodiment 2. The buffer memory device 200 according to Embodiment 2 differs from the buffer memory device 100 according to Embodiment 1 in the processing performed when determined that the attribute is cacheable (S105 in FIG. 6 and FIG. 9). Therefore, in the following, the different points are mainly described, and the descriptions of the same points may be omitted.

First, in the similar manner to Embodiment 1, the buffer memory device 200 executes read processing according to Embodiment 2 upon receipt of a read request from the processor 10.

As shown in FIG. 6, the attribute obtaining unit 110 obtains the attribute of the area indicated by the read address, with reference to the area attribute table 161 (S101). The attribute determining unit 120 then determines the attribute obtained by the attribute obtaining unit 110 from among cacheable, burst-transferable and non-burst-transferable attribute (S102).

When the attribute determining unit 120 determines that the attribute of the area indicated by the read address is burst-transferable (“uncacheable (burst-transferable) in S102), first transfer processing is executed (S103: details are shown in FIG. 7). When determined that the attribute of the area indicated by the read address is non-burst-transferable (“uncacheable (non-burst-transferable) in S102), second transfer processing is executed (S104: details are shown in FIG. 8).

When determined that the attribute of the area indicated by the read address is cacheable (“cacheable” in S102), the third data reading unit 233 executes third transfer processing (S105). The third transfer processing is processing executed when the attribute is cacheable and processing where, when transferring data to the processor 10, the data is read from the main memory 20 and stored in the cache memory 150.

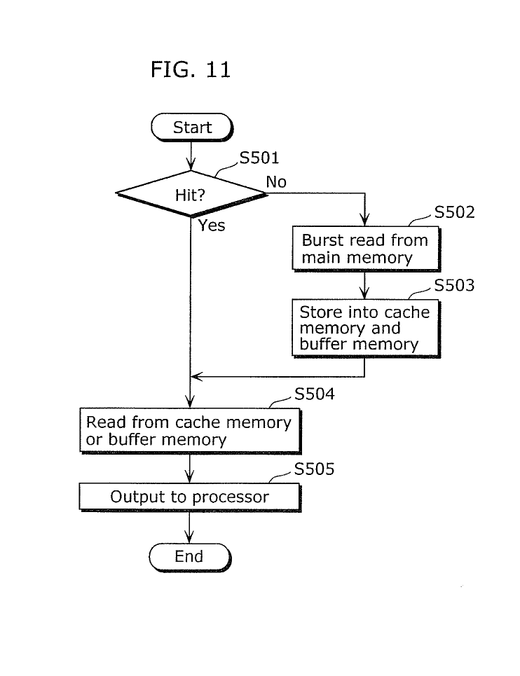

Here, reference is made to FIG. 11. FIG. 11 is a flowchart of the details of transfer processing performed when the attribute is cacheable.

The third data reading unit 233 determines whether the read request is a hit or a miss (S501). When the read request is a miss (No in S501), the third data reading unit 233 performs a burst read of data including read data (burst read data) from the main memory 20 (S502). The third data reading unit 233 stores the burst read data into the cache memory 150 and the buffer memory 140 (S503). Furthermore, the third data reading unit 233 reads read data from the cache memory 150 (S504) and outputs the data to the processor 10 (S505). Here, the storage of the burst read data into the cache memory 150 may be executed at the same time as the output of the read data to the processor 10.

When the read request is a hit (Yes in S501), the third data reading unit 233 reads read data corresponding to the read request from the cache memory 150 or the buffer memory 140 (S504). The third data reading unit 233 then outputs the data to the processor 10 (S505).

In such a manner, when determined that the attribute of the area indicated by the read address is cacheable, the buffer memory device 200 according to Embodiment 2 performs a burst read of data including data corresponding to the read address and stores the data into the cache memory 150 and the buffer memory 140.

Accordingly, also when the read request for the cacheable area is output from the processor 10, the buffer memory 140 can be used. More specifically, memory access at the time of reading can be accelerated by performing a burst read of data more than the data corresponding to the read request, and storing the burst read data in the buffer memory 140.

### Embodiment 3

In a memory system according to Embodiment 3, a Memory Management Unit (MMU) which manages a main memory or an Operating System (OS) sets the attributes of the areas of the main memory.

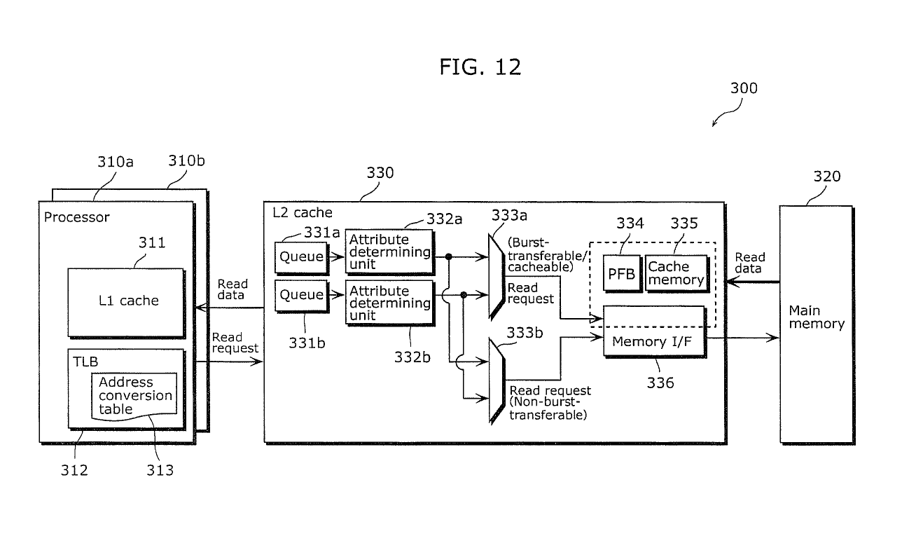

FIG. 12 is a block diagram illustrating a structure of the memory system according to Embodiment 3. A memory system 300 in FIG. 12 includes processors 310a and 310b, a main memory 320, and an L2 cache 330. The memory system 300 according to Embodiment 3 is a system including a multiprocessor including the processor 310a and the processor 310b.

The processor 310a includes an L1 cache 311 and a Translation Lookaside Buffer (TLB) 312, and is, for example, a CPU which outputs memory access requests (read requests or write requests) to the main memory 320. The processor 310a also manages the main memory 320 by using the internal or external MMU and OS.

More specifically, the processor 310a manages an address conversion table in which physical addresses and logical addresses of the main memory 320 are associated. The processor 310a further sets the attribute of the area indicated by a physical address of the main memory 320, and stores the set attribute in association with the physical address, in the TLB 312 which holds the address conversion table. The processor 310a corresponds to the attribute setting unit 170 in Embodiments 1 and 2.

The processor 310b is a processor having the structure same as that of the processor 310a. The processors 310a and 310b may be two processors that are physically different, or may be two virtual processors into which a single processor is virtually divided by the OS.

The L1 cache 311 and the TLB 312 may be provided for each processor. Furthermore, the L1 cache 311 and the TLB 312 may be provided between the processor 310a and the L2 cache 330.

The L1 cache 311 obtains a memory access request issued by the processor 310a, and determines whether the obtained memory access request (read request or write request) is a hit or a miss. The L1 cache 311 corresponds to the L1 cache 30 in Embodiments 1 and 2.

When the read request is a hit, the L1 cache 311 reads data corresponding to the read address included in the read request from inside the L1 cache 311, and outputs the data to the processor 310a. When the write request is a hit, the L1 cache 311 writes, into the L1 cache 311, the data output from the processor 310 at the same time as the write request.

When the read request is a miss, the L1 cache 311 reads data corresponding to the read request from the L2 cache 330 or the main memory 320, and outputs the data to the processor 310a. When the write request is a miss, the L1 cache 311 writes data output from the processor 310a at the same time as the write request, into the L2 cache 330 or the main memory 320.

The TLB 312 is a cache memory which stores the address conversion table 313. The TLB 312 corresponds to the table holding unit 160 in Embodiments 1 and 2.

The address conversion table 313 is a table in which logical addresses, physical addresses, and the attributes of the areas indicated by the physical addresses are associated with each other. The address conversion table 313 corresponds to the area attribute table 161 in Embodiments 1 and 2.

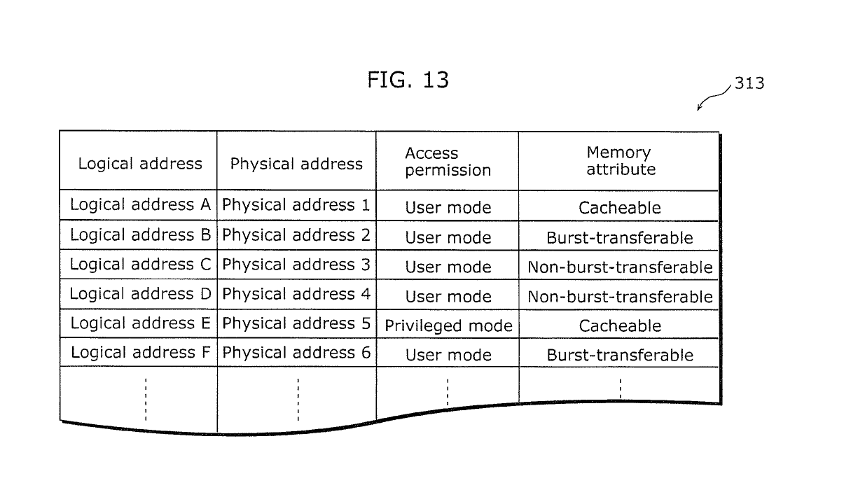

Here, reference is made to FIG. 13. FIG. 13 is a diagram illustrating an example of the address conversion table according to Embodiment 3. As shown in FIG. 13, the address conversion table 313 is a table in which logical addresses, physical addresses, access permissions, and memory attributes are associated with one another.

The logical addresses are addresses virtually set by the processor 310a and may also be referred to as virtual addresses. The physical addresses are addresses which indicate actual write or read areas of the main memory 320, and may also be referred to as actual addresses. The access permissions indicate one of two attributes that are “privileged mode” and “user mode”. The privileged mode represents that the area is accessible only by the managing unit such as the OS. The “user mode” represents that the area is accessible also by a general program. The memory attribute indicates the attribute of the area from among the cacheable, burst-transferable, and non-burst-transferable area.

The example in FIG. 13 shows that “logical address C” indicates the area indicated by “physical address 3” in the main memory 320, and that the area is in the “user mode” and the “non-burst-transferable area”. Therefore, data cannot be burst read from the area indicated by the “logical address C”.

Returning back to FIG. 12, the main memory 320 is a storage unit, such as an SDRAM, which stores programs or data. In accordance with a memory access request (a read request or a write request) output from the processors 310a, 310b or the like, data is read from the main memory 320, or data is written to the main memory 320. The main memory 320 corresponds to the main memory 20 in Embodiments 1 and 2.

The L2 cache 330 obtains the memory access request output from the processor 310a or 310b, and determines whether the obtained memory access request is a hit or a miss. The L2 cache 330 corresponds to the L2 cache 40 (the cache memory 150) in Embodiments 1 and 2.

In the following description, for simplicity, it is assumed that the memory access request input to the L2 cache 330 is issued by the processor 310a. However, the memory access request may be issued by other processors (for example, processor 310b), a Direct Memory Access Controller (DMAC) or the like.

When the read request is a hit, the L2 cache 330 reads data corresponding to the read address included in the read request from inside the L2 cache 330, and outputs the data to the processor 310a. When the write request is a hit, the L2 cache 330 writes, into the L2 cache 330, the data output from the processor 310a at the same time as the write request.

When the read request is a miss, the L1 cache 311 reads data corresponding to the read request from the L2 cache 330 or the main memory 320, and outputs the data to the processor 310a. When the write request is a miss, the L1 cache 311 writes data output from the processor 310a at the same time as the write request, into the L2 cache 330 or the main memory 320.

The L2 cache 330 includes queues 331a and 331b, attribute determining units 332a and 332b, selectors 333a and 333b, a PFB 334, a cache memory 335, and a memory interface 336.

The queue 331a is a First In First Out (FIFO) memory which temporarily holds the memory access request output from the processor 310a. The held memory access request includes an address, and the attribute of the area indicated by the address.

The queue 331b has the structure same as that of the queue 331a, and an FIFO memory which temporarily holds the memory access request output from the processor 310b.

The queues 331a and 331b correspond to the attribute obtaining unit 110 in Embodiments 1 and 2.

The attribute determining unit 332a reads the memory access request held by the queue 331a, and determines the attribute included in the read memory access request from among cacheable, burst-transferable, and non-burst-transferable attribute. In accordance with the determination result, the attribute determining unit 332a outputs the memory access request, to the memory interface 336, or to the PFB 334 and the cache memory 335 via the selector 333a or 333b and the memory interface 336.

More specifically, when determined that the attribute is cacheable or burst-transferable, the attribute determining unit 332a outputs the memory access request to the PFB 334 and the cache memory 335 via the selector 333a and the memory interface 336. When determined that the attribute is non-burst-transferable, the attribute determining unit 332a outputs the memory access request to the main memory 320 via the selector 333b and the memory interface 336.

The attribute determining unit 332b has the structure same as that of the attribute determining unit 332a. The attribute determining unit 332b reads the memory access request held by the queue 331b and determines the attribute included in the memory access request.

The attribute determining units 332a and 332b correspond to the attribute determining unit 120 in Embodiments 1 and 2.

The selectors 333a and 333b determine the memory access request to be arbitrated from among the memory access requests input from the two queues 331a and 331b via the attribute determining unit 332a and 332b. The selectors 333a and 333b then select the output destination of the arbitrated memory access request from among the PFB 334, the cache memory 335, and the main memory 320. The arbitrated memory access request is output to the selected destination via the memory interface 336.

The PFB 334 is a buffer memory which stores the address of the main memory 320 in association with the data read from the area indicated by the address. The PFB 334 in used for prefetch processing which previously holds data that is likely to be read by the processor 310a or the like in response to a read request from the processor 310a or the like. The PFB 334 corresponds to the buffer memory 140 in Embodiments 1 and 2.

The cache memory 335 is a cache memory for holding data read from the main memory 320. The cache memory 335 corresponds to the cache memory 150 in Embodiments 1 and 2.

The memory interface 336 determines whether or not the read request is a hit or a miss, and reads data from the main memory 320, the PFB 334 or the cache memory 335 in accordance with the determination result. The memory interface 336 corresponds to the data reading unit 130 (230) in Embodiments land 2.

For example, when the attribute of the area indicated by the read address included in the read request is non-burst-transferable, the memory interface 336 reads data from the main memory 320 and outputs the data to the processor 310a.

When the attribute of the area indicated by the read address included in the read request is burst-transferable, the memory interface 336 determines whether the read request is a hit or a miss. When the read request is a hit, corresponding read data is read from the PFB 334 and output to the processor 310a. When the read request is a miss, data including corresponding read data is burst read from the main memory 320, and the burst read data is written to the PFB 334. The read data is read from the PFB 334 and output to the processor 310a.

Furthermore, when the attribute of the area indicated by the read address included in the read request is cacheable, the memory interface 336 determines whether the read request is a hit or a miss. When the read request is a hit, corresponding read data is read from the cache memory 335 and output to the processor 310a. When the read request is a miss, data including corresponding read data is read from the main memory 320 and the data is written to the cache memory 335. The data is read from the cache memory 335, and output to the processor 310a. Here, similar to Embodiment 2, it may be that data is burst read from the main memory 320 and stored in the cache memory 335 and the PFB 334.

Next, operations of the memory system 300 according to Embodiment 3 is described. The operations of the memory system 300 according to Embodiment 3 is similar to those in Embodiments 1 or 2; and thus, simple descriptions are given with reference to the flowcharts in FIGS. 6 to 9.

First, for example, a read request output from the processor 310a is stored in the queue 331a. Here, the read request includes the attribute that is obtained by referring to the address conversion table 313 (S101).

The attribute determining unit 332a determines the attribute included in the read request from among cacheable, burst-transferable, and non-burst-transferable attribute (S102). The determination result is output to the memory interface 336 via the selector 333a or the like.

When determined that the attribute included in the read request is burst-transferable (“uncacheable (burst-transferable)” in S102) the memory interface 336 executes first transfer processing (S103).

As shown in FIG. 7, the memory interface 336 determines whether the read request is a hit or a miss (S201). When the read request is a miss (No in S201), the memory interface 336 performs a burst read of burst read data including read data from the main memory 20 (S202). The memory interface 336 then stores the burst read data into the PFB 334 (S203). The memory interface 336 further reads read data from the PFB 334 (S204) and outputs the data to the processor 310a (S205).

When the read request is a hit (Yes in S201), the memory interface 336 further reads read data from the PFB 336 (S204) and outputs the data to the processor 310a (S205).

Returning to FIG. 6, when determined that the attribute included in the read request is non-burst-transferable (“uncacheable (non-burst-transferable in S102)”), the memory interface 336 executes second transfer processing (S104).

As shown in FIG. 8, the memory interface 336 reads read data from the main memory 320 (S301). The memory interface 336 then outputs the data to the processor 310a (S302).

Returning to FIG. 6 again, when determined that the attribute included in the read request is cacheable (“cacheable” in S102), the memory interface 336 executes third transfer processing (S105).

As shown in FIG. 9, the memory interface 336 determines whether the read request is a hit or a miss (S401). When the read request is a miss (No in S401), the memory interface 336 reads read data from the main memory 320 (S402). The memory interface 336 then stores the data into the cache memory 335 (S403). The memory interface 336 further reads read data from the cache memory 335 (S404) and outputs the data to the processor 310a (S405).

When the read request is a hit (Yes in S401), the memory interface 336 reads read data from the cache memory 335 (S404) and outputs the data to the processor 310a (S405).

When determined that the attribute included in the read request is cacheable (“cacheable” in S102) and the read request is a miss (No in S401), the memory interface 336 may perform a burst read of data including read data from the main memory 320 (flowchart shown in FIG. 11). Here, the burst read data is stored into the cache memory 335 and the PFB 334.

In such a manner, in the memory system 300 according to Embodiment 3, the MMU or the like within the processor sets the attribute and stores the set attribute in the address conversion table held by the TLB. Accordingly, the conventional address conversion table may be used, which does not require a separate buffer dedicated for storing attributes. As a result, a simple structure of the memory system 300 is possible.

### Embodiment 4

A buffer memory device according to Embodiment 4 temporarily holds data that is output from the processor and that is to be written to the main memory, and performs a burst write of the held data when one or more predetermined conditions are met. Accordingly, data bus can be effectively used, which allows efficient data transfer.

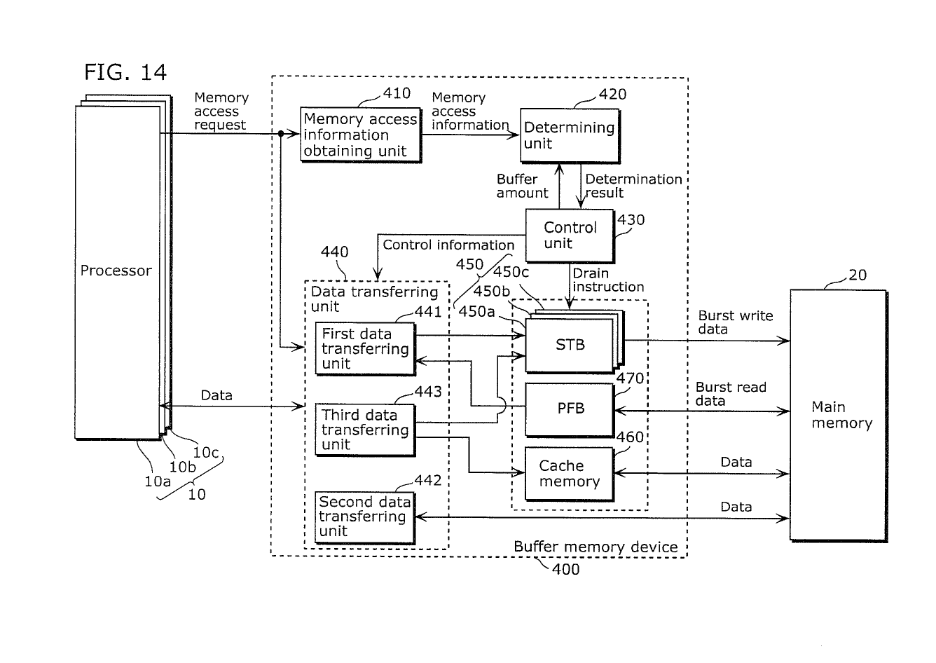

FIG. 14 is a block diagram illustrating a structure of the buffer memory device according to Embodiment 4. A buffer memory device 400 shown in FIG. 14 transfers data between processors 10a, 10b, and 10c and a main memory 20, in accordance with a memory access request issued by the processor 10a, 10b, or 10c. In the following description, when it is not particularly necessary to identify the processor 10a, 10b, or 10c, they are simply referred to as a processor 10.

It is assumed that the buffer memory device 400 is provided on the chip same as the L2 cache 40 shown in FIG. 1. It is also assumed that the L1 cache 30 shown in FIG. 1 is provided for each of the processors 10a, 10b, and 10c, and they are not shown in FIG. 14. It may be that the L1 cache 30 is provided between the processors 10a, 10b, and 10c and the buffer memory device 400, and is commonly used among the processors 10a, 10b and 10c.

As shown in FIG. 14, the buffer memory device 400 includes a memory access information obtaining unit 410, a determining unit 420, a control unit 430, a data transferring unit 440, Store Buffers (STB) 450a, 450b, and 450c, a cache memory 460, and a PFB 470. In the following description, when it is not particularly necessary to identify the STB 450a, 450b or 450c, they are simply referred to as an STB 450.

The memory access information obtaining unit 410 obtains a memory access request from the processor 10, and obtains, from the obtained memory access request, memory access information indicating the type of the memory access request issued by the processor 10. The memory access information is information included in the memory access request or information attached thereto, and includes command information, address information, attribute information, processor information and the like.

The command information is information indicating whether the memory access request is a write request or a read request, and other commands related to data transfer. The address information is information indicating a write address indicating the area into which data is written or a read address indicating the area from which data is read. The attribute information is information indicating the attribute of the area indicated by the write address or the read address from among cacheable, burst-transferable, and non-burst-transferable attribute. The processor information is information indicating a thread, a logical processor (LP), and a physical processor (PP) which have issued the memory access request.

The attribute information may not be included in the memory access request. In this case, it may be that the memory access information obtaining unit 410 holds a table in which addresses of the main memory 20 are associated with the attributes of the areas indicated by the addresses, and obtains the attribute information with reference to address information and the table.

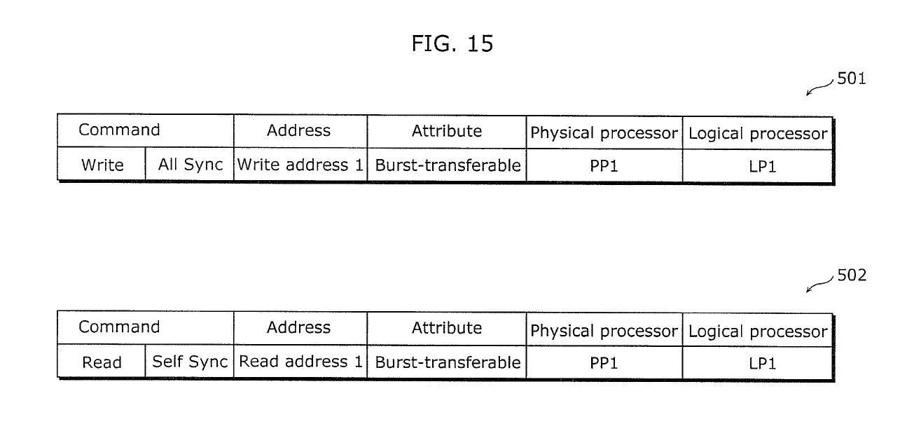

Here, reference is made to FIG. 15. FIG. 15 is a diagram illustrating an example of memory access information according to Embodiment 4. In FIG. 15, the memory access information 501 and 502 are shown.

The memory access information 501 indicates that a memory access request is a write request issued by the logical processor “LP1” of the physical processor “PP1” and that the memory access request includes a write command indicating that data is to be written to the burst-transferable area indicated by the “write address 1”. It is also indicated that the write request includes an “All Sync” command.

The memory access information 502 indicates that a memory access request is a read request issued by the logical processor “LP 1” of the physical processor “PP1”, and the memory access request includes a read command indicating that data is to be read from the burst-transferable area indicated by the “read address 1”. It is also indicated that the read request includes a “Self Sync” command.

Detailed descriptions of the “All Sync” and “Self Sync” commands are given later.

Returning to FIG. 14, the determining unit 420 determines whether or not the type of the memory access information obtained by the memory access information obtaining unit 410 meets predetermined conditions. More specifically, the determining unit 420 determines if the conditions are met, by using the command information, attribute information, address information and processor information obtained as the memory access information, and buffer amount information obtained from the STB 450 via the control unit 430. The detailed descriptions of the conditions and processing performed by the determining unit 420 are given later. The buffer amount information is information indicating the amount of data held in each STB 450.

When the determining unit 420 determines that the type indicated by the memory access information meets the conditions, the control unit 430 drains, to the main memory, the data that is held in the STB, among the STB 450a, 450b and 450c, which meets the conditions. More specifically, the control unit 430 outputs a drain command to the STB 450. The drain command is output to the STB that drains data, and the STB which receives the drain command outputs the held data to the main memory 20.

The control unit 430 controls the data transferring unit 440 by outputting control information to the data transferring unit 440. For example, the control information includes at least attribute information. The control unit 430 determines the write destination of write data, read destination of read data, and the like, in accordance with the attribute of the area indicated by the address.

The control unit 430 further outputs, to the determining unit 420, the buffer amount that is amount of data held in the respective STB 450a, 450b, and 450c.

The data transferring unit 440 transfers data between the processor 10 and the main memory 20 under the control of the control unit 430. More specifically, when a write request is output from the processor 10, the write data output from the processor 10 to be written to the main memory 20 is written to one of the STB 450, the cache memory 460, and the main memory 20. When the read request is output from the processor 10, read data is read from one of the cache memory 460, the PFB 470, and the main memory 20, and the data is output to the processor 10. The used memory is determined by the control unit 430 depending on the attribute of the area indicated by the address.

As shown in FIG. 14, the data transferring unit 440 includes a first data transferring unit 441, a second data transferring unit 442, and a third data transferring unit 443.

The first data transferring unit 441 transfers data when the area indicated by the address has the burst-transferable attribute. When the write request is input, the first data transferring unit 441 writes write data corresponding to the write request to the STB 450. The STB 450a, 450b, or 450c to which data is written is determined in accordance with the processor information included in control information. More specifically, data is written to the STB corresponding to the processor that has issued the write request.

When the read request is input, the first data transferring unit 441 determines whether or not the read data corresponding to the read request is held in the PFB 470. In other words, it is determined whether the read request is a hit or a miss. When the read request is a hit, the first data transferring unit 441 reads corresponding read data from the PFB 470, and outputs the data to the processor 10. When the read request is a miss, the first data transferring unit 441 performs a burst read of data including read data corresponding to the read request, from the main memory 20, and writes the burst read data to the PFB 470. The read data corresponding to the read request is then read from the PFB 470, and output to the processor 10. It may be that at the same time as writing the burst read data read from the main memory 20 to the PFB 470, read data corresponding to the read request is output to the processor 10.

The second data transferring unit 442 transfers data when the area indicated by the address has the non-burst-transferable attribute. When the write request is input, the second data transferring unit 442 writes write data corresponding to the write request to the main memory 20. When the read request is input, the second data transferring unit 442 reads read data corresponding to the read request from the main memory 20, and outputs the data to the processor 10.

The third data transferring unit 443 transfers data when the area indicated by the address has the cacheable attribute.

When the write request is input, write destination of the write data is different depending on whether the third data transferring unit 443 performs a write-back operation or a write-through operation.

When the write-back operation is performed, the third data transferring unit 443 determines whether the write request is a hit or a miss. When the write request is a hit, the write data is written to the cache memory 460. When the write request is a miss, the third data transferring unit 443 performs refill processing on the cache memory 460, and writes an address (tag address) included in the write request and write data to the cache memory 460. In any cases, the write data written to the cache memory 460 is written to the main memory 20 with a given timing. When the write request is a miss, it may be that write data is written to the main memory 20 directly without writing the write data to the cache memory 460.

When the write-through operation is performed, the third data transferring unit 443 determines whether the write request is a hit or a miss. When the write request is a hit, the third data transferring unit 443 writes write address and write data to the STB 450. The write data written to the STB 450 is burst written to the cache memory 460 and the main memory 20 from the STB 450 under the control of the control unit 430, when the determining unit 420 determines that the type of the subsequent memory access request meets the conditions.

When the write request is a miss, the third data transferring unit 443 also writes write address and write data to the STB 450 in the similar manner. The write data and write address written to the STB 450 are burst written to the cache memory 460 and the main memory 20 from the STB 450, when the determining unit 420 determines that the type of the subsequent memory access request meets the conditions.

When the read request is input, the third data transferring unit 443 determines whether the read request is a hit or a miss. When the read request is a hit, the third data transferring unit 443 reads read data from the cache memory 460, and outputs the data to the processor 10.

When the read request is a miss, the third data transferring unit 443 reads read data from the main memory 20, and writes the read data and read address to the cache memory 460. The third data transferring unit 443 then reads read data from the cache memory 460 and outputs the data to the processor 10. The read data read from the main memory 20 may be output to the processor 10 at the same time as writing to the cache memory 460.

The STB 450a, 450b, and 450c respectively correspond to the processors 10a, 10b, and 10c, and are store buffers (STB) which hold write data corresponding to the write request issued by a corresponding processor. The STB 450 are buffer memories which temporarily hold write data so as to merge the write data output from the processors 10.

In Embodiment 4, the STB 450 is provided for each physical processor. As an example, the STB 450 is capable of holding data of 128 bytes at maximum. The data held in the STB 450 is burst written to the main memory 20 under the control of the control unit 430. In the case where the write request is an access to an area which has the cacheable attribute and where a write-through operation is performed, the data held in the STB 450 is burst written to the main memory 20 and the cache memory 460.

Here, reference is made to FIG. 16. FIG. 16 is a diagram schematically illustrating the STBs 450 included in the buffer memory device 400 according to Embodiment 4.

As shown in FIG. 16, the STB 450a, 450b, and 450c are respectively provided for the physical processors (processors 10a (PP0), 10b (PP1), and 10c (PP2)). In other words, the STB 450a holds buffer control information such as the write address output from the processor 10a and write data. The STB 450b holds buffer control information such as the write address output from the processor 10b and write data. The STB 450c holds buffer control information such as the write address output from the processor 10c and write data.

The buffer control information is information included in a write request, and is information for managing data to be written to the STB 450. More specifically, the buffer control information includes at least a write address, and includes information indicating the physical processor and logical processor which outputted corresponding write data.

In the example shown in FIG. 16, the STB provided for each physical processor includes two areas each of which can hold data of 64 bytes. For example, these two areas may be associated with respective threads.

The cache memory 460 is, for example, a four-way set associative cache memory, similar to the cache memory 150 in Embodiment 1.

The PFB 470 corresponds to the buffer memory 140 in Embodiment 1, and is a buffer memory which stores the addresses of the main memory 20 in association with the data read by the first data transferring unit 441 from the areas indicated by the addresses.

Here, reference is made to the conditions used for determination processing performed by the determining unit 420.

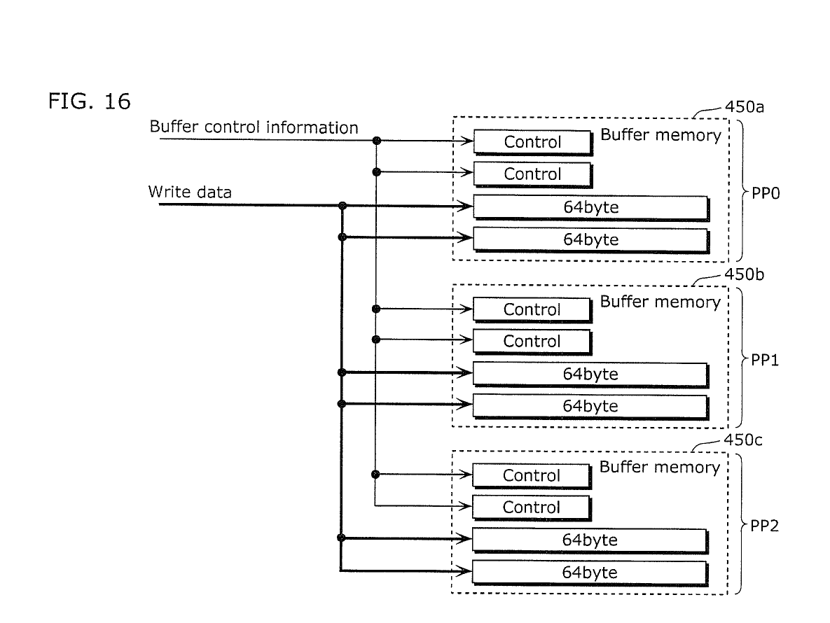

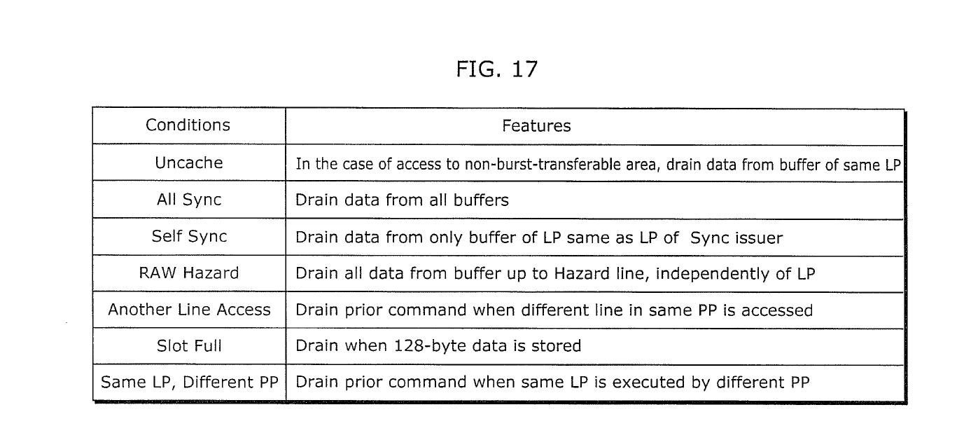

FIG. 17 is a diagram of a determination table showing examples of determining conditions according to Embodiment 4. In FIG. 17, the following conditions are shown as examples: attribute determining condition (“Uncache”); command determining condition (“All Sync” and “Self Sync”); address determining condition (“RAW Hazard” and “Another Line Access”); buffer amount determining condition (“Slot Full”); and processor determining condition (“same LP, different LP”).

The attribute determining condition is a condition for determining, using the attribute information, whether to drain data from the STB 450 and the STB which drains data, in accordance with the attribute of the area indicated by the address included in the memory access request. The condition “Uncache” shown in FIG. 17 is an example of the attribute determining condition.

The condition “Uncache” is used by the determining unit 420 for determining whether or not the attribute of the area indicated by the address included in the memory access request is non-burst-transferable. When determined as non-burst-transferable, the control unit 430 drains data from the STB to the main memory 20. The data drained here corresponds to the memory access request issued by the logical processor same as the logical processor which has issued the memory access request. As a criteria of determination of the STB which drains data, the control unit 430 may use a virtual processor which corresponds to a thread, instead of the logical processor.

The command determining condition is a condition for determining, using the command information, whether to drain data from the STB 450 and the STB which drains data, in accordance with the command included in the memory access request. The conditions “All Sync” and “Self Sync” shown in FIG. 17 are examples of the command determining condition.

The condition “All Sync” is used by the determining unit 420 for determining whether or not the memory access request includes the “All Sync” command. The “All Sync” command is a command for draining, to the main memory 20, all data held in all of the STBs 450. When the “All Sync” command is included (for example, the memory access information 501 in FIG. 15), the control unit 430 drains, to the main memory 20, all data held in the all of the STBs 450.

The condition “Self Sync” is used by the determining unit 420 for determining whether or not the memory access request includes the “Self Sync” command. The “Self Sync” command is a command for draining, from the STB 450 to the main memory 20, only the data output from the processor which has issued the command. When the “Self Sync” command is included (for example, the memory access information 502 in FIG. 15), the control unit 430 drains data from the STB to the main memory 20. The data drained here corresponds to the memory access request issued by the logical processor same as the logical processor which has issued the memory access request. As a criteria of determination of the STB which drains data, the control unit 430 may use a virtual processor which corresponds to a thread, instead of the logical processor.

The address determining condition is a condition for determining, using address information, whether to drain data from the STB 450 and the STB which drains data, in accordance with the address included in the memory access request. The conditions “RAW Hazard” and “Another Line Access” shown in FIG. 17 are examples of the address determining condition.

The condition “RAW Hazard” is used by the determining unit 420 for determining whether or not the write address which matches the read address included in the read request is held in at least one of the STBs 450. When the write address which matches the read address is held in one of the STBs 450, the control unit 430 drains all data up to the Hazard line to the main memory 20. More specifically, the control unit 430 drains the data held in the STB 450 prior to the write data corresponding to the write address.

The condition “Another Line Access” is used by the determining unit 420 for determining whether or not the write address included in the write request is related to the write address included in the immediately prior write request. More specifically, it is determined whether or not the two write addresses are continuous. Here, it is assumed that the two write requests are issued by the same physical processor. When determined that the two write addresses are not continuous, the control unit 430 drains, to the main memory 20, the data held in the STB 450 prior to the write data corresponding to the immediately prior write request.

The buffer amount determining condition is a condition for determining, using the buffer amount information, whether to drain data from the STB 450 and the STB which drains data, in accordance with the data amount in the STB 450. The condition “Slot Full” shown in FIG. 17 is an example of the buffer amount determining condition.

The condition “Slot Full” is used by the determining unit 420 for determining whether or not the buffer amount that is the amount of data held in the STB 450 is full (128 bytes). When determined that the buffer amount is 128 bytes, the control unit 430 drains the data in the STB to the main memory 20.

The processor determining condition is a condition for determining, using the processor information, whether to drain data from the STB 450, and the STB which drains data, in accordance with the logical processor and the physical processor which have issued the memory access request. The condition “same LP, different PP” shown in FIG. 17 is an example of the processor determining condition.

The condition “same LP, different PP” is used for determining whether or not the logical processor which has issued the memory access request is the same as the logical processor which issued the write request corresponding to the write data held in the STB 450. Furthermore, it is determined whether or not the physical processor which has issued the memory access request is different from the physical processor which issued the write request. More specifically, the determining unit 420 determines whether or not at least one of the STBs holds write data that corresponds to the write request issued previously by the physical processor that is different from the physical processor indicated by the processor information and the logical processor that is the same as the logical processor indicated by the processor information. When determined that the logical processor is the same and the physical processor is different, the control unit 430 drains, from the STB 450, data corresponding to the write request previously issued by the logical processor. It may be that whether or not the thread is the same is determined, instead of the logical processor.

As described, in Embodiment 4, data is drained from the STB 450 when the respective conditions are met. Note that it is not necessary that all of the described conditions are met. Furthermore, a different condition may be added to the above conditions, or a different condition may be replaced with the above conditions.

For example, the condition “Slot Full” is a condition for determining whether or not the buffer amount is full. Instead of this condition, a condition for determining whether or not a predetermined buffer amount (for example, half of the maximum value of the buffer amount that can be held in the STB) is reached. For example, the maximum amount of data that can be held in the STB 450 is 128 bytes. In the case where the data bus width between the STB 450 and the main memory 20 is 64 bytes, it may be determined whether or not the buffer amount reaches 64 bytes.

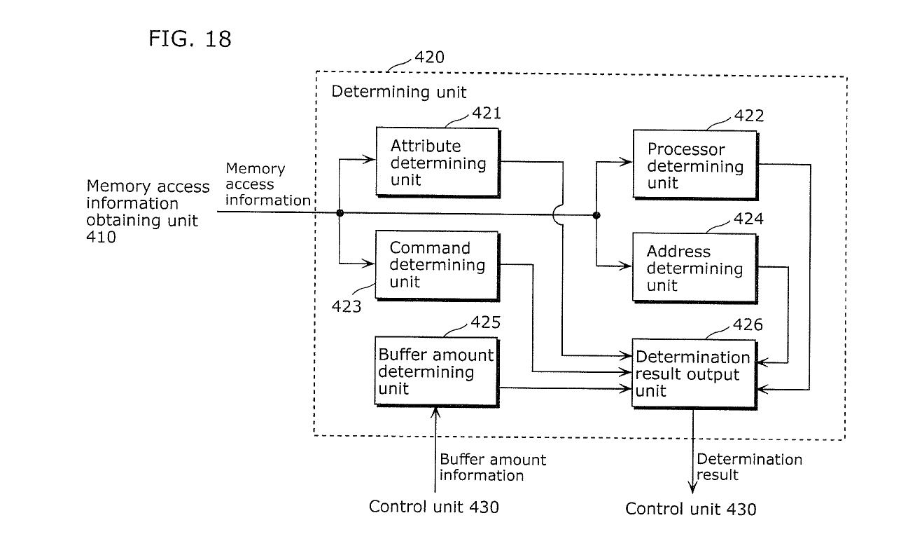

Here, reference is made to FIG. 18. FIG. 18 is a block diagram illustrating a detailed structure of the determining unit 420 according to Embodiment 4. As shown in FIG. 18, the determining unit 420 includes an attribute determining unit 421, a processor determining unit 422, a command determining unit 423, an address determining unit 424, a buffer amount determining unit 425, and a determination result output unit 426.

The attribute determining unit 421 obtains attribute information from the memory access information obtained by the memory access information obtaining unit 410, and determines the attribute of the area indicated by the address included in the memory access request from among the cacheable, burst-transferable, and non-burst-transferable attribute. The attribute determining unit 421 outputs the obtained determination result to the determination result output unit 426.

The processor determining unit 422 obtains processor information from the memory access information obtained by the memory access information obtaining unit 410, and determines the logical processor and the physical processor which have issued the memory access request from among logical processors and physical processors. The processor determining unit 422 outputs the obtained determination result to the determination result output unit 426.

The command determining unit 423 obtains command information from the memory access information obtained by the memory access information obtaining unit 410, and determines whether or not the memory access request includes one or more predetermined commands. Furthermore, when the memory access request includes the predetermined command, the command determining unit 423 determines the type of the predetermined command. The command determining unit 423 outputs the obtained determination result to the determination result output unit 426.

The predetermined command is, for example, a command for draining data from the STB 450 independently of other conditions. Examples of the predetermined command include the “All Sync” command and “Self Sync” command.

The address determining unit 424 obtains address information from the memory access information obtained by the memory access information obtaining unit 410, and determines whether or not the address included in the memory access request is already held in the STB 450. The address determining unit 424 further determines whether or not the address included in the memory access request is related to the address included in the immediately prior memory access request. More specifically, it is determined whether or not two addresses are continuous. The address determining unit 424 outputs the obtained determination result to the determination result output unit 426.

The buffer amount determining unit 425 obtains the buffer amount from the STB 450 via the control unit 430, and determines, for each STB, whether or not the buffer amount reaches a predetermined threshold. The buffer amount determining unit 425 outputs the obtained determination result to the determination result output unit 426. Examples of the predetermined threshold include the maximum value of the STB 450, and the data bus width between the buffer memory device 400 and the main memory 20.

The determination result output unit 426 determines whether the conditions shown in FIG. 17 are met, based on the determination results input from the respective determining units, and outputs the obtained determination result to the control unit 430. More specifically, when determined that the conditions shown in FIG. 17 are met, the determination result output unit 426 outputs, to the control unit 430, drain information indicating which data in which STB is to be drained to the main memory 20.

According to the above structure, the buffer memory device 400 according to Embodiment 4 includes a plurality of STBs 450 which temporarily hold write data output from a plurality of processors 10, and performs a burst write of data held in the STB 450 to the main memory 20 when predetermined conditions are met. More specifically, in order to merge small-size write data, the write data is temporarily held in the STB 450, and the large-size data obtained by the merge is burst written to the main memory 20. Here, it is determined whether or not the data is drained from the STB 450, based on a condition for guaranteeing the order of data between the processors.

Accordingly, efficiency of data transfer can be increased while maintaining data coherency.

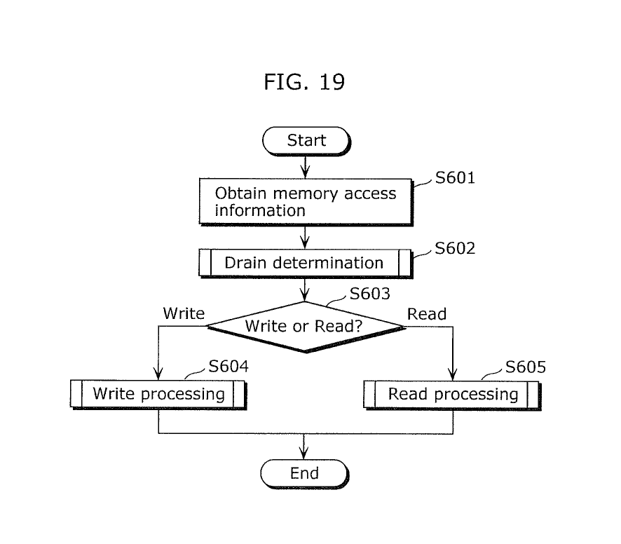

Next, reference is made to the operations of the buffer memory device 400 according to Embodiment 4, with reference to FIGS. 19 to 26. FIG. 19 is a flowchart of the operations of the buffer memory device 400 according to Embodiment 4.

First, the buffer memory device 400 according to Embodiment 4 executes data transfer according to Embodiment 4 upon receipt of a memory access request from the processor 10.

The memory access information obtaining unit 410 obtains memory access information from the memory access request (S601). The obtained memory access information is output to the determining unit 420. The determining unit 420 obtains buffer amount information from the STB 450 via the control unit 430 as necessary.

The determining unit 420 determines whether or not data is to be drained from the STB 450, based on the received memory access information and the obtained buffer amount information (S602). Detail description of the drain determination will be given later.

The command determining unit 423 then determines whether the memory access request is a write request or a read request (S603). When the memory access request is a write request (“Write” in S603), the data transferring unit 440 performs write processing of write data output from the processor 10 (S604). When the memory access request is a read request (“Read” in S603), the data transferring unit 440 executes read processing of read data to the processor 10 (S605).

In the case where it is determined in the drain determination processing (S602) whether the memory access request is a write request or a read request, write processing (S604) or read processing (S605) may be executed after the drain determination processing (S602) without determination processing of the memory access request (S603).

In the following, first, details of the write processing (S604) are given.

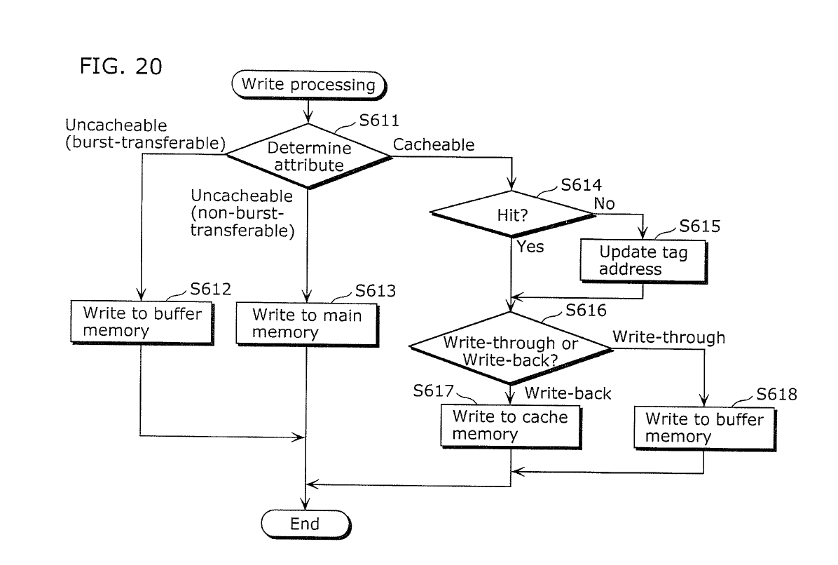

FIG. 20 is a flowchart of the write processing of the buffer memory device 400 according to Embodiment 4.

When the memory access request is a write request, the attribute determining unit 421 first determines the attribute of the area indicated by the write address included in the write request (S611). More specifically, the attribute determining unit 421 determines the attribute of the area indicated by the write address from among the burst-transferable, non-burst-transferable and cacheable attribute.

When determined that the attribute of the area indicated by the write address is burst-transferable (“uncacheable (burst-transferable)” in S611), the first data transferring unit 441 writes write data output from the processor 10 to the STB 450 (S612). More specifically, the first data transferring unit 441 writes write data to the STB (for example, STB 450a) corresponding to the physical processor that has issued the write request (processor 10a), under the control of the control unit 430.

When determined that the attribute of the area indicated by the write address is non-burst-transferable (“uncacheable (non-burst-transferable)” in S611), the second data transferring unit 442 writes, to the main memory 20, the write data output from the processor 10 (S613).

When determined that the attribute of the area indicated by the write address is cacheable (“cacheable” in S611), the third data transferring unit 443 determines whether the write request is a hit or a miss (S614). When the write request is a miss (No in S614), the third data transferring unit 443 performs refill processing on the cache memory 460, and updates a tag address (S615).

After the update of the tag address, or when the write request is a hit (Yes in S614), the control unit 430 changes the writing destination of the write data depending on whether the write processing based on the write request is a write-back operation or a write-through operation (S617). In the case of the write-back operation (“write-back” in S616), the third data transferring unit 443 writes write data to the cache memory 460 (S617). In the case of the write-through operation (“write-through” in S616), the third data transferring unit 443 writes write data and write address to the STB 450 (S618).

In such a manner, the write data output from the processor 10 is written to the main memory 20, the STB 450, or the cache memory 460. The data written to the STB 450 or the cache memory 460 is written to the main memory 20 by the drain determination processing executed when the subsequent access request is input or the like.

In the case where the attribute of the area indicated by the write address is determined in the drain determination processing (S602), respective write processing may be executed after the determination processing of the memory access request (S603) without the attribute determination processing (S611).

Next, read processing (S605) is described. The read processing (S605) is executed according to the flowcharts shown in FIGS. 6 to 9, for example.

In the case where the attribute of the area indicated by the read address is determined in the drain determination processing (S602), respective read processing may be executed after the determination processing of the memory access request (S603), without the attribute obtaining processing (S101) and the attribute determination processing (S102).

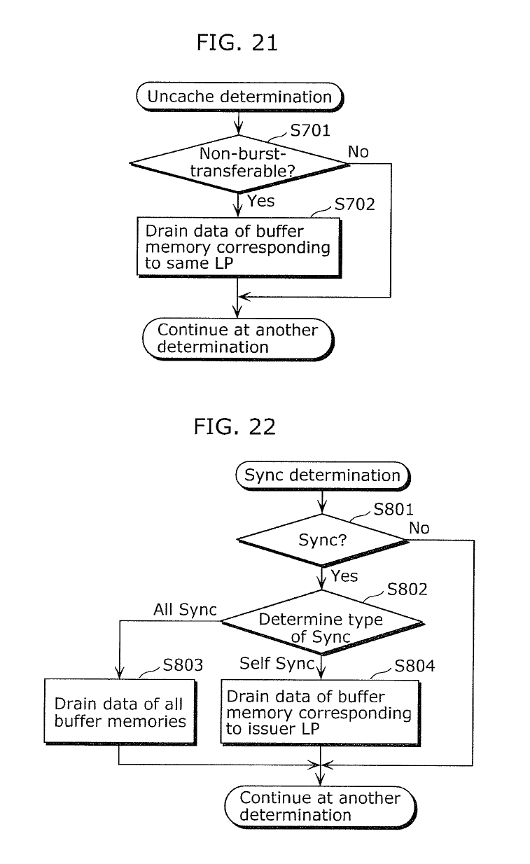

Next, details of the drain determination processing (S602) are given with reference to FIGS. 21 to 26. In the drain determination processing, the conditions indicated in the determination table shown in FIG. 17 may be determined in any order. However, it is preferable to preferentially execute a condition which eliminates the need for subsequent determination of the other conditions. Examples of such condition include the condition “All Sync” in which data held in all buffers is drained when the condition is met.

FIG. 21 is a flowchart of the attribute determination processing of the buffer memory device 400 according to Embodiment 4. FIG. 21 shows the details of the drain determination processing based on the condition “Uncache” in FIG. 17.

When the determining unit 420 receives the memory access information, the attribute determining unit 421 determines whether or not the attribute of the area indicated by the address included in the memory access request is non-burst-transferable (S701). When the attribute of the area indicated by the address is not non-burst-transferable (No in S701), another determination processing is executed.

When determined that the attribute of the area indicated by the address included in the memory access request is non-burst-transferable (Yes in S701), the control unit 430 drains data from the STB to the main memory 20. The data drained here corresponds to the memory access request issued by the logical processor same as the logical processor which has issued the memory access request. The control unit 430 executes data drain by identifying the STB which drains data from among the STBs 450 based on the determination result of the processor determining unit 422. After the draining, another determination processing is executed (S702).

FIG. 22 is a flowchart of the command determination processing of the buffer memory device 400 according to Embodiment 4. FIG. 22 shows the drain determination processing based on the conditions “All Sync” and “Self Sync” in FIG. 17.

When the determining unit 420 receives the memory access information, the command determining unit 423 determines whether the command included in the memory access request includes the “Sync” command that is a command for draining data independently of the other conditions (S801). When the memory access request does not include the “Sync” command (No in S801), another determination processing is executed.

When the memory access request includes the “Sync” command (Yes in S801), the command determining unit 423 determines whether the “Sync” command is the “All Sync” command or “Self Sync” command (S802). When the “Sync” command is the “All Sync” command (“All Sync” in S802), the control unit 430 drains all data from all of the STBs 450 (S803).

When the “Sync” command is the “Self Sync” command (“Self Sync” in S802), the control unit 430 drains data from the STB to the main memory 20. The data drained here corresponds to the memory access request issued by the logical processor same as the logical processor which has issued the memory access request (S804). The control unit 430 executes data drain by identifying the STB, from among the STBs 450, which drains data, based on the determination result of the processor determining unit 422.

After the data drain, another determination processing is executed.

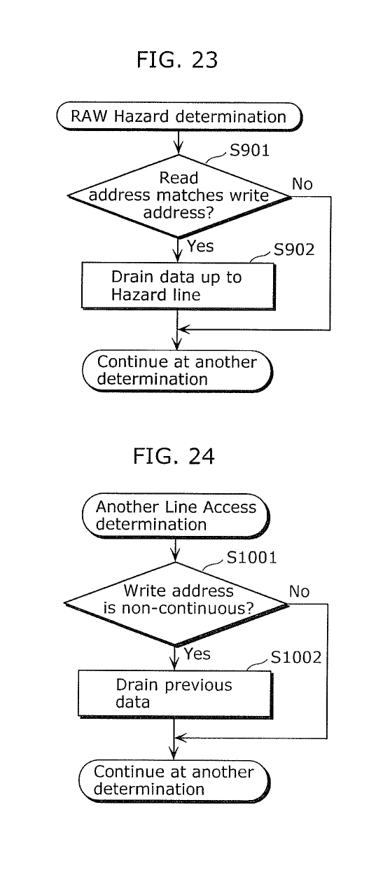

FIG. 23 is a flowchart of the read address determination processing of the buffer memory device 400 according to Embodiment 4. FIG. 23 shows the drain determination processing based on the condition “RAW Hazard” in FIG. 17. The condition “RAW Hazard” is a condition used when the buffer memory device 400 receives a read request. In other words, when the command determining unit 423 determines that the memory access request is a read request, the condition “RAW Hazard is used.

The address determining unit 424 determines whether or not the read address included in the read request matches the write address held in the STB 450 (S901). When determined that the read address does not match the write address held in the STB 450 (No in S901), another determination processing is executed.

When determined that the read address matches the write address held in the STB 450 (Yes in S901), the control unit 430 drains, from the STB 450, all of data up to the Hazard line, that is, all of the data held prior to the write data corresponding to the matched write address (S902). After the data drain, another determination processing is executed.

FIG. 24 is a flowchart of the write address determination processing of the buffer memory device 400 according to Embodiment 4. FIG. 24 shows the drain determination processing based on the condition “Another Line Access” in FIG. 17. The condition “Another Line Access” is a condition used when the buffer memory device 400 receives a write request. In other words, when the command determining unit 423 determines that the memory access request is a write request, the condition “Another Line Access” is used.

The address determining unit 424 determines whether or not the write address included in the write request is continuous with the write address included in the immediately prior write request (S1001). When the two addresses are continuous (No in S1001), another determination processing is executed.

When the two addresses are not continuous (Yes in S1001), the control unit 430 drains the write data corresponding to the immediately prior write request, and all the prior data from the STB 450 (S1002). After the data drain, another determination processing is executed.

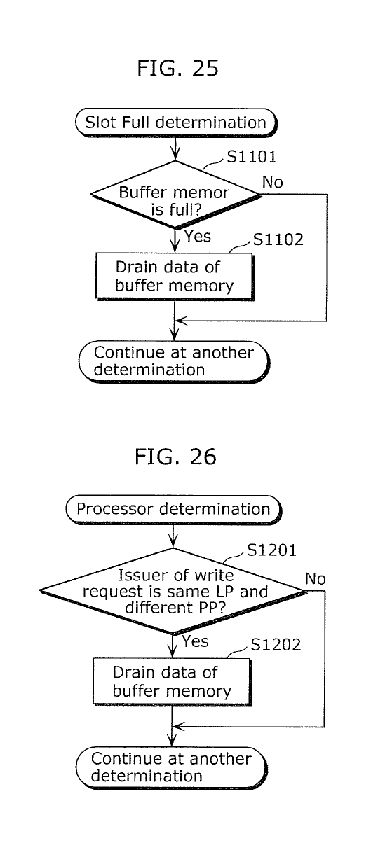

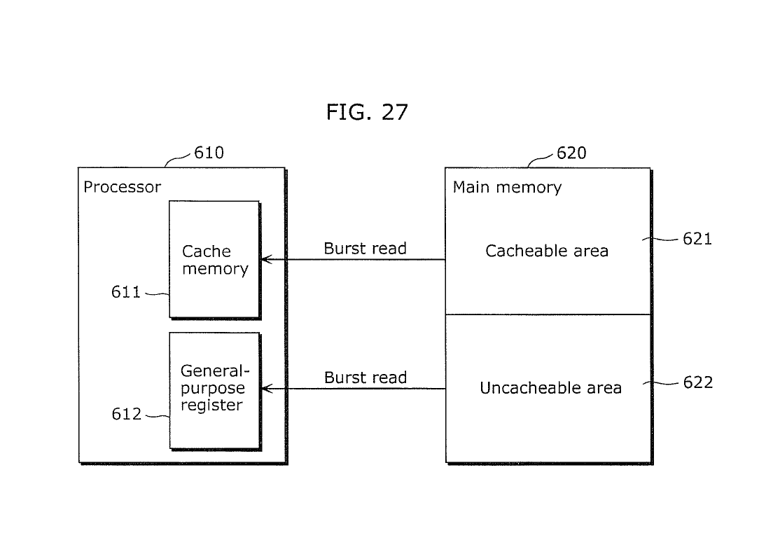

FIG. 25 is a flowchart of the buffer amount determination processing of the buffer memory device 400 according to Embodiment 4. FIG. 25 shows the drain determination processing based on the condition “Slot Full” in FIG. 17.

The condition “Slot Full” is different from the other conditions, and is a condition used for determination based on not the memory access information, but the buffer amount information obtained from the STB 450. Thus, the condition “Slot Full” may be used only when the buffer memory device 400 receives a memory access request but also at any timings or when data is written to the STB 450.

The buffer amount determining unit 425 obtains buffer amount information from the STB 450 via the control unit 430, and determines, for each STB, whether or not the buffer amount is full (S1101). In the case where the buffer amount is not full (No in S1101), another determination processing is executed when the buffer memory device 400 receives the memory access request.

When the buffer amount is full (Yes in S1101), the control unit 430 drains data from the STB having full buffer amount among the STBs 450 (S1102). After the data drain, another determination processing is executed.

FIG. 26 is a flowchart of the processor determination processing of the buffer memory device 400 according to Embodiment 4. FIG. 26 shows the drain determination processing based on the condition “same LP, different PP” in FIG. 17.

When the determining unit 420 receives memory access information, the processor determining unit 422 determines whether the STB 450 holds write data corresponding to the memory access request that is previously issued by the logical processor that is the same as the logical processor that has issued the memory access request and a physical processor that is different from the physical processor that issued the memory access request (S1201).

When the STB 450 holds the write data output from the same logical processor and different physical processor (Yes in S1201), the data is drained from the STB which holds the write data (S1202). After the data drain, another determination processing is executed.

After the determination processing shown in FIGS. 21 to 26, the drain determination processing (S602 in FIG. 19) ends.

When the conditions used in the drain determination processing are not met, the write data corresponding to the write request is held in the STB 450. In other words, the input small-size write data is merged in the STB 450 to be large-size data. The data is burst written to the main memory 20 when any of the conditions is met.

In the above description, data is drained to the main memory 20 each time respective determining conditions are met; however, after all of the determination of the conditions, data corresponding to the met conditions may be collectively drained to the main memory 20.

As described, the buffer memory device 400 according to Embodiment 4 includes the STB 450 provided for each of the processors 10. Each STB 450 merges the write data output from the processor 10 for storage. When one or more predetermined conditions are met, the merged data is burst written to the main memory from the STB 450.

Accordingly, the large-size data obtained by merging small-size write data can be burst written to the main memory 20; and thus, efficiency of data transfer can be increased compared to the case where small-size data is separately written. Furthermore, by including conditions for reading data from the STB 450, coherency between write data output from a plurality of processors can be maintained. In particular, by draining data held in the STB 450 in the case where the memory access request is issued by the logical processor, but the different physical processor, data coherency can be maintained even in the case of the multi-threading executed by a plurality of processors, or a memory system using a multi-processor.

The buffer memory device and the memory system according to the present invention have been described based on the embodiments; however, the present invention is not limited to these embodiments. Those skilled in the art will readily appreciate that many modifications are possible in the exemplary embodiment without materially departing from the novel teachings and advantages of this invention. Accordingly, all such modifications are intended to be included within the scope of this invention.

In each embodiment, the issuer of the memory access request may be a processor such as a CUP, or any masters such as a DMAC.

In each embodiment, it has been described that the L2 cache 40 includes the buffer memory 140, the PFB 334 or the PFB 470; however, it may be that the L1 cache 30 includes the buffer memory 140, PFB 334, or the PFB 470. Here, it may be that the memory system does not include the L2 cache 40.

Furthermore, the present invention may be applied to a memory system including a cache higher than the level 3 cache. In this case, it is preferable that the highest level cache, that is, the cache closest to the main memory 20 includes the buffer memory 140, the PFB 334, or the PFB 470.

As described, the present invention may be implemented not only as a buffer memory device, a memory system, and a data reading method, but also as a program causing a computer to execute the data reading method according to the embodiments. The present invention may also be implemented as a recording medium such as a computer-readable CD-ROM which stores the program. Furthermore, the present invention may also be implemented as information, data, or signals indicating the program. Such program, information, data and signals may be distributed via a communication network such as the Internet.

In addition, part or all of the elements in the buffer memory device may include a single system Large Scale Integration (LSI). The system LSI, which is a super-multifunctional LSI manufactured by integrating elements on a single chip, is specifically a computer system which includes a microprocessor, a ROM, a RAM and the like.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The buffer memory device and the memory system according to the present invention may be used in a system where data is transferred between a processor such as a CPU and a main memory. For example, the present invention may be applied to a computer.

What is claimed is:

1. A buffer memory device which reads data from a main memory or a peripheral device in response to a read request from a processor, the main memory and the peripheral device including a plurality of areas each having either a cacheable attribute or an uncacheable attribute, said buffer memory device comprising:
an attribute obtaining unit configured to obtain an attribute of an area indicated by a read address included in the read request;
an attribute determining unit configured to determine whether or not the attribute obtained by said attribute obtaining unit is a first attribute which (i) is the uncacheable attribute and (ii) indicates that data to be burst transferred is to be held;
a data reading unit configured to perform a burst read of data including data held in the area indicated by the read address, when said attribute determining unit determines that the attribute obtained by said attribute obtaining unit is the first attribute; and
a first buffer memory which holds the data burst read by said data reading unit.

2. The buffer memory device according to claim 1,
wherein said attribute determining unit is configured to determine whether the attribute obtained by said attribute obtaining unit is the first attribute or a second attribute which (i) is the uncacheable attribute and (ii) indicates that data to be burst transferred is not to be held, and
said data reading unit is further configured to read only data held in the area indicated by the read address, when said attribute determining unit determines that the attribute obtained by said attribute obtaining unit is the second attribute.

3. The buffer memory device according to claim 2, further comprising
a table holding unit configured to hold a table in which an address of the main memory or the peripheral device is associated with attribute information, the attribute information indicating the attribute of the area indicated by the address from among the first attribute, the second attribute, and a third attribute that is the cacheable attribute,
wherein said attribute obtaining unit is configured to obtain the attribute of the area indicated by the read address with reference to the table held by said table holding unit.

4. The buffer memory device according to claim 3, further comprising
a cache memory,
wherein said attribute determining unit is configured to determine the attribute obtained by said attribute obtaining unit from among the first attribute, the second attribute, and the third attribute,
said data reading unit is further configured to perform a burst read of data including data held in the area indicated by the read address, when said attribute determining unit determines that the attribute obtained by said attribute obtaining unit is the third attribute,
said cache memory holds first data including data held in the area indicated by the read address out of the data burst read by said data reading unit, and
said first buffer memory holds second data from among the data burst read by said reading unit, the second data excluding the first data.

5. The buffer memory device according to claim 3, further comprising
an attribute setting unit configured to generate the table by setting the attribute of the area indicated by the address of the main memory or the peripheral device to one of the first attribute, the second attribute, and the third attribute,
wherein said table holding unit is configured to hold the table generated by said attribute setting unit.

6. The buffer memory device according to claim 1,
wherein said data reading unit is further configured to:
when said attribute determining unit determines that the attribute obtained by said attribute obtaining unit is the first attribute, determine whether or not the data held in the area indicated by the read address is already held in said first buffer memory;
when the data is already held in said first buffer memory, read the data from said first buffer memory; and
when the data is not held in said first buffer memory, perform a burst read of data including the data held in the area indicated by the read address.

7. The buffer memory device according to claim 1,
wherein said attribute obtaining unit is further configured to obtain an attribute of an area indicated by a write address included in a write request from the processor,
said buffer memory device further comprises:
a second buffer memory which holds write data that corresponds to the write request and that is to be written to the main memory or the peripheral device, when said attribute determining unit determines that the attribute of the area indicated by the write address out of the attribute obtained by said attribute obtaining unit is the first attribute;
a memory access information obtaining unit configured to obtain memory access information indicating a type of the memory access request that is the read request or the write request from the processor;
a condition determining unit configured to determine whether or not the type indicated by the memory access information obtained by said memory access information obtaining unit or the attribute obtained by said attribute obtaining unit meets a predetermined condition; and
a control unit configured to drain the write data held in said second buffer memory to the main memory or the peripheral device, when said condition determining unit determines that the type indicated by the memory access information meets the predetermined condition.

8. The buffer memory device according to claim 7,
wherein said memory access information obtaining unit is configured to obtain, as the memory access information, processor information indicating a logical processor and a physical processor which have issued the memory access request,
said condition determining unit is configured to determine that the predetermined condition is met, in the case where said second buffer memory holds write data corresponding to a write request previously issued by (i) a physical processor that is different from the physical processor indicated by the processor information and (ii) a logical processor that is same as the logical processor indicated by the processor information, and
when said condition determining unit determines that the predetermined condition is met, said control unit is configured to drain, to the main memory or the peripheral device, the data held in said second buffer memory which meets the predetermined condition.

9. The buffer memory device according to claim 7,
wherein said condition determining unit is configured to determine whether or not the memory access information includes command information for draining the data held in said second buffer memory to the main memory or the peripheral device, and
when said condition determining unit determines that the memory access information includes the command information, said control unit is configured to drain, to the main memory or the peripheral device, the data indicated by the command information and held in said second buffer memory.

10. The buffer memory device according to claim 7,
wherein said memory access information obtaining unit is further configured to obtain, as the memory access information, processor information indicating a processor which has issued the memory access request,
said condition determining unit is further configured to determine whether or not the attribute indicated by the attribute information is the first attribute, and
when said condition determining unit determines that the attribute obtained by said attribute obtaining unit is the first attribute, said control unit is further configured to drain, to the main memory or the peripheral device, the data held in said second buffer memory corresponding to the processor indicated by the processor information.

11. The buffer memory device according to claim 7,
wherein said second buffer memory further holds a write address corresponding to the write data,
when the memory access request includes the read request, said memory access information obtaining unit is further configured to obtain, as the memory access information, a read address included in the read request,
said condition determining unit is configured to determine whether or not a write address which matches the read address is held in said second buffer memory, and
when said condition determining unit determines that the write address which matches the read address is held in said second buffer memory, said control unit is configured to drain, to the main memory or the peripheral device, the data held in said second buffer memory prior to the write data corresponding to the write address.

12. The buffer memory device according to claim 7,
wherein, when the memory access request includes the write request, said memory access information obtaining unit is further configured to obtain a first write address included in the write request,
said condition determining unit is configured to determine whether or not the first write address is continuous with a second write address included in an immediately prior write request, and
when said condition determining unit determines that the first write address is continuous with the second write address, said control unit is configured to drain, to the main memory or the peripheral device, the data held in said second buffer memory prior to write data corresponding to the second write address.

13. The buffer memory device according to claim 7,
wherein said condition determining unit is further configured to determine whether or not an amount of data held in said second buffer memory reaches a predetermined threshold, and
when said condition determining unit determines that the data amount reaches the predetermined threshold, said control unit is further configured to drain the data held in said second buffer memory to the main memory or the peripheral device.

14. The buffer memory device according to claim 1, further comprising
an invalidating unit configured to determine whether or not a write address included in a write request from the processor matches an address of the data held in said first buffer memory, and to invalidate the data held in said first buffer memory when the write address matches the address of the data held in said first buffer memory.

15. A memory system comprising (i) a processor and (ii) a main memory or a peripheral device which includes a plurality of areas each having either a cacheable attribute or an uncacheable attribute,
wherein data is read from said main memory or said peripheral device in response to a read request from said processor,
said system further comprises:
an attribute obtaining unit configured to obtain an attribute of an area indicated by a read address included in the read request from said processor;
an attribute determining unit configured to determine whether or not the attribute obtained by said attribute obtaining unit is a first attribute which (i) is the uncacheable attribute and (ii) indicates that data to be burst transferred is to be held;
a data reading unit configured to perform a burst read of data including data held in the area indicated by the read address, when said attribute determining unit determines that the attribute obtained by said attribute obtaining unit is the first attribute; and
a buffer memory which holds the data burst read by said data reading unit,
wherein said data reading unit is further configured to:
when said attribute determining unit determines that the attribute obtained by said attribute obtaining unit is the first attribute, determine whether or not the data held in the area indicated by the read address is already held in said buffer memory;
when the data is already held in said buffer memory, read the data from said buffer memory; and
when the data is not held in said buffer memory, perform a burst read of data including the data held in the area indicated by the read address.

16. The memory system according to claim 15, further comprising
a plurality of caches,
wherein said buffer memory is included in a cache, among said caches, which is closest to said main memory or said peripheral device.

17. A method of reading data from a main memory or a peripheral device in response to a read request from a processor, the main memory and the peripheral device including a plurality of areas each having either a cacheable attribute or an uncacheable attribute, said method comprising:
obtaining an attribute of an area indicated by a read address included in the read request from the processor; and
determining whether or not the attribute obtained in said obtaining is a first attribute which (i) is the uncacheable attribute and (ii) indicates that data to be burst transferred is to be held;
when determined in said determining of the attribute that the attribute obtained in said obtaining is the first attribute, determining whether or not data held in the area indicated by the read address is already held in the buffer memory,
when determined in said determining of the data that the data is already held in the buffer memory, reading the data from the buffer memory, and
when determined in sad determining of the data that the data is not held in the buffer memory, performing a burst read of data including the data held in the area indicated by the read address and storing the burst read data into the buffer memory.
